(19) United States
(12) Patent Application Publication
(10) Pub. No.: US 2023/0041774 A1
(43) Pub. Date: Feb. 9, 2023

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Koji YASUDA, Kanagawa (JP); Hiroaki MOCHIZUKI, Kanagawa (JP)

(73) Assignee: FUJIFILM Corporation, Tokyo (JP)

(21) Appl. No.: 17/899,626

(22) Filed: Aug. 31, 2022

Related U.S. Application Data
(63) Continuation of application No. PCT/JP2021/012347, filed on Mar. 24, 2021.

(30) Foreign Application Priority Data
Mar. 31, 2020 (JP) 2020-061882

(51) Int. Cl. H01M 10/056

(52) U.S. Cl. CPC H01M 10/056; H01M 2300/0082; H01M 10/0525

(57) ABSTRACT

There is provided an inorganic solid electrolyte-containing inorganic solid electrolyte-containing composition, a dispersion medium, and a polymer binder, where a component constituting the polymer binder contains a soluble polymer having a combination of specific functional groups or partial structures. There are also provided a sheet for an all-solid state secondary battery and an all-solid state secondary battery, in which this inorganic solid electrolyte-containing composition is used, as well as manufacturing methods for a sheet for an all-solid state secondary battery, and an all-solid state secondary battery.

This application is a Continuation of PCT International Application No. PCT/JP2021/012347 filed on Mar. 24, 2021, which claims priority under 35 U.S.C. § 119 (a) to Japanese Patent Application No. 2020-061882 filed in Japan on Mar. 31, 2020. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Background Art

In an all-solid state secondary battery, all of a negative electrode, an electrolyte, and a positive electrode consist of solid, and the all-solid state secondary battery can greatly improve safety and reliability, which are said to be problems to be solved in a battery in which an organic electrolytic solution is used. It is also said to be capable of extending the battery life. Furthermore, all-solid state secondary batteries can be provided with a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, examples of substances that form constitutional layers (a solid electrolyte layer, a negative electrode active material layer, a positive electrode active material layer, and the like) include an inorganic solid electrolyte and an active material. In recent years, this inorganic solid electrolyte, particularly an oxide-based inorganic solid electrolyte or a sulfide-based inorganic solid electrolyte has attracted attention as an electrolyte material having a high ion conductivity comparable to that of the organic electrolytic solution.

As the material that forms a constitutional layer (a constitutional layer forming material) of an all-solid state secondary battery, a material containing the above-described inorganic solid electrolyte and the like has been proposed. For example, JP2015-088486A discloses a solid electrolyte composition including an inorganic solid electrolyte (A) having an ion conductivity of a metal belonging to Group 1 or Group 2 of the periodic table; a binder particle (B) having an average particle diameter of 10 nm or more and 1,000 nm or less, which are composed of a polymer into which a macromonomer (X) having a number average molecular weight of 1,000 or more is incorporated as a side chain component; and a dispersion medium (C).

### SUMMARY OF THE INVENTION

Constitutional layers of an all-solid state secondary battery are formed of solid particles (an inorganic solid electrolyte, an active material, a conductive auxiliary agent, and the like), and thus the interfacial contact state between solid particles is restricted, and interface resistance tends to increase (ion conductivity tends to decrease).

As the interface resistance between solid particles increases, the battery resistance of an all-solid state secondary battery also increases. Further, the increase in battery resistance is further accelerated by the void between the solid particles, which is generated due to the charging and discharging of an all-solid state secondary battery, which consequently leads to the deterioration of the cycle characteristics of the all-solid state secondary battery.

The increase in battery resistance is due to not only the interfacial contact state between solid particles but also the non-uniform presence (the arrangement) of solid particles in the constitutional layer, as well as the surface flatness of the constitutional layer. As a result, in a case where a constitutional layer is formed of a constitutional layer forming material, not only the dispersibility of the solid particles immediately after preparation but also characteristics (dispersion stability) that stably maintains the dispersibility of the solid particles immediately after preparation, and characteristics (handleability) that facilitate the formation of a coating film having a flat surface (having good surface properties) are also required.

However, JP2015-088486A has not carried out examinations based on such a viewpoint. Moreover, in recent years, research and development for improving the performance and the practical application of electric vehicles have progressed rapidly, and the demand for battery performance (for example, cycle characteristics) required for an all-solid state secondary battery has become higher.

An object of the present invention is to provide an inorganic solid electrolyte-containing composition excellent in dispersion stability and handleability, where the inorganic solid electrolyte-containing composition is capable of realizing the suppression of the further increase in battery resistance and the excellent cycle characteristics in a case of being used as a constitutional layer forming material of an all-solid state secondary battery. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of repeated various studies focusing on a polymer binder that is used in combination with solid particles such as an inorganic solid electrolyte, the inventors of the present invention have found that the above objects can be achieved by reacting a binder precursor to solidify or precipitate a polymer binder at the time of the film formation, where the binder precursor is in a dissolved state in an inorganic solid electrolyte-containing composition, as a polymer binder that is used in combination with an inorganic solid electrolyte and a dispersion medium.

That is, it has been found that in an inorganic solid electrolyte-containing inorganic solid electrolyte-containing composition and a dispersion medium, it is possible to from a coating film having a flat surface while suppressing temporal reaggregation or sedimentation of solid particles such as an inorganic solid electrolyte by individually introducing functional groups or partial structures, which exhibit mutual reactivity, into a soluble polymer that exhibits solubility in the dispersion medium. Further, it has been found that at the time of forming a film using the inorganic solid electrolyte-containing composition, it is possible to bind the inorganic solid electrolytes to each other while suppressing an increase in interface resistance by solidifying or precipitating a binder while generating it by subjecting the functional groups or partial structures of the soluble polymer to a chemical reaction with each other. As a result, it has been found that by using this inorganic solid electrolyte-containing composition as a constitutional layer forming material, it is possible to form a constitutional layer having a flat surface, where solid particles are bound to each other, while suppressing the increase in interface resistance between solid particles, and it is possible to manufacture an all-solid state secondary battery that is capable of realizing the suppression of the increase in battery resistance and the excellent cycle characteristics.

The present invention has been completed through further studies based on these findings.

That is, the above problems have been solved by the following means.

<1> An inorganic solid electrolyte-containing composition comprising:

an inorganic solid electrolyte having an ion conductivity of a metal belonging to Group 1 or Group 2 in the periodic table;

the following component constituting a polymer binder; and

a dispersion medium,

in which the component constituting a polymer binder includes a polymer defined in at least one of the following (C1) or (C2),

(C1) a soluble polymer C1-I having at least one functional group or partial structure selected from the following group (I), and a soluble polymer C1-II having at least one functional group or partial structure selected from the following group (II),

(C2) a soluble polymer C2 having each of at least one functional group or partial structure selected from the following group (I), and at least one functional group or partial structure selected from the following group (II),

Group (I): a hydroxyl group, a primary or secondary amino group, and a 1,3-dicarbonyl structure,

Group (II): a blocked isocyanate group, a boronate group or borinate group, a boronic acid ester group or borinic acid ester group, and an acid anhydride structure.

<2> The inorganic solid electrolyte-containing composition according to <1>, in which at least one of the soluble polymers has 50% by mass or more of a constitutional component derived from a (meth)acrylic monomer or a vinyl monomer.

<3> The inorganic solid electrolyte-containing composition according to <1> or <2>, in which the inorganic solid electrolyte is a sulfide-based inorganic solid electrolyte.

<4> The inorganic solid electrolyte-containing composition according to any one of <1> to <3>, in which the dispersion medium contains at least one selected from a ketone compound, an aliphatic compound, or an ester compound.

<5> The inorganic solid electrolyte-containing composition according to any one of <1> to <4>, further comprising an active material.

<6> The inorganic solid electrolyte-containing composition according to any one of <1> to <5>, further comprising a conductive auxiliary agent.

<7> A sheet for an all-solid state secondary battery, comprising a layer formed of the inorganic solid electrolyte-containing composition according to any one of <1> to <6>.

<8> An all-solid state secondary battery comprising, in the following order, a positive electrode active material layer; a solid electrolyte layer; and a negative electrode active material layer,

in which at least one of the positive electrode active material layer, the solid electrolyte layer, or the negative electrode active material layer is a layer formed of the inorganic solid electrolyte-containing composition according to any one of <1> to <6>.

<9> A manufacturing method for a sheet for an all-solid state secondary battery, the manufacturing method comprising forming a film of the inorganic solid electrolyte-containing composition according to any one of <1> to <6>.

<10> A manufacturing method for an all-solid state secondary battery, comprising manufacturing an all-solid state secondary battery through the manufacturing method according to <9>.

According to the present invention, it is possible to provide an inorganic solid electrolyte-containing composition excellent in dispersion stability and handleability (dispersion characteristics), where the inorganic solid electrolyte-containing composition is capable of realizing the suppression of the further increase in battery resistance (the increase in ion conductivity) and the excellent cycle characteristics in a case of being used as a constitutional layer forming material of an all-solid state secondary battery. In addition, according to the present invention, it is possible to provide a sheet for an all-solid state secondary battery and an all-solid state secondary battery, which have a layer formed of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type all-solid state secondary battery prepared in Examples.

FIG. 3 is a diagram illustrating measurement points for layer thickness in the handling test in Example.

### DESCRIPTION OF THE PREFERRED EMBODIMENTS

In the present invention, a numerical range indicated using “to” means a range including numerical values before and after the “to” as the lower limit value and the upper limit value.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described below.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it is synonymous with a so-called polymeric compound. Further, a polymer binder means a binder constituted of a polymer and includes a polymer itself and a binder formed by containing a polymer.

[Inorganic Solid Electrolyte-Containing Composition]

The inorganic solid electrolyte-containing composition according to the embodiment of the present invention contains an inorganic solid electrolyte having an ion conductivity of a metal belonging to Group 1 or Group 2 in the periodic table; a constitutional component constituting a polymer binder; and a dispersion medium.

The component constituting a polymer binder, contained in the inorganic solid electrolyte-containing composition, constitutes a polymer binder in a constitutional layer formed of an inorganic solid electrolyte-containing composition, and it functions as a binder that binds solid particles of an inorganic solid electrolyte (as well as a co-existable active material, conductive auxiliary agent, and the like) or the like to each other (for example, solid particles of an inorganic solid electrolyte to each other, solid particles of an inorganic solid electrolyte and an active material to each other, or an active material to each other). Further, it may function as a binder that binds a collector to solid particles.

The component constituting a polymer binder (also referred to as a precursor compound of the polymer binder) contains a polymer (a combination of polymers) defined in at least one of the following (C1) and (C2) in the inorganic solid electrolyte-containing composition. In the present invention, each polymer defined in (C1) or (C2) can be combined; however, it is preferable to contain a polymer defined in one of (C1) and (C2).

It is conceived that the two soluble polymers C1 defined in (C1) or the soluble polymer C2 defined in (C2) is usually present in an inorganic solid electrolyte-containing composition, in a state where a functional group or partial structure selected from the group (I) or (II) described later does not undergo a chemical reaction between the soluble polymers or within the soluble polymer. However, a part thereof (for example, a part in a range in which the solubility or dispersion characteristics in a dispersion medium can be maintained) may constitute the polymer binder. On the other hand, the polymer binder is constituted to include the soluble polymer defined in the following (C1) or (C2) in the constitutional layer, and it is formed in a case where functional groups or partial structures contained in these soluble polymers undergo chemical bonding (covalent bonding), for example, at the time of forming a coating film.

(C1) A soluble polymer C1-I having at least one functional group or partial structure selected from the following group (I), and a soluble polymer C1-II having at least one functional group or partial structure selected from the following group (II)

(C2) A soluble polymer C2 having each of at least one functional group or partial structure and at least one functional group or partial structure, respectively selected from the following group (I) and the following group (II)

—Group (I)—

A hydroxyl group, a primary or secondary amino group, and a 1,3-dicarbonyl structure

—Group (II)—

A blocked isocyanate group, a boronate group or borinate group, a boronic acid ester group or borinic acid ester group, and an acid anhydride structure

In the inorganic solid electrolyte-containing composition, a constitutional component constituting a polymer binder and the polymer binder may have or may not have a function of causing solid particles to mutually bind therebetween.

The inorganic solid electrolyte-containing composition according to the embodiment of the present invention is preferably a slurry in which the inorganic solid electrolyte is dispersed in a dispersion medium. In the inorganic solid electrolyte-containing composition, the soluble polymer defined in the above (C1) or (C2) is dissolved in a dispersion medium, and at least one of the soluble polymers C1-I and C1-II defined in (C1) or the soluble polymer C2 defined in (C2) has a function of dispersing solid particles such as an inorganic solid electrolyte in a dispersion medium by being adsorbed thereto. Here, the adsorption of the soluble polymer to the solid particles includes not only physical adsorption but also chemical adsorption (adsorption by chemical bond formation, adsorption by transfer of electrons, or the like).

The inorganic solid electrolyte-containing composition according to the embodiment of the present invention is excellent in dispersion stability and handleability. In a case where this inorganic solid electrolyte-containing composition is used as a constitutional layer forming material, it is possible to realize a sheet for an all-solid state secondary battery, which has a low-resistance constitutional layer having a flat surface and excellent surface properties, and as well as an all-solid state secondary battery which is excellent cycle characteristics.

In the aspect in which the active material layer formed on the collector is formed of the inorganic solid electrolyte-containing composition according to the aspect of the present invention, the adhesiveness between the collector and the active material layer is also excellent, and thus it is possible to achieve a further improvement of the cycle characteristics.

Although the details of the reason for the above are not yet clear, they are conceived to be as follows. That is, it is conceived that in the inorganic solid electrolyte-containing composition, the soluble polymer defined in the above (C1) or (C2) as a constitutional component constituting a polymer binder is usually dissolved in a dispersion medium in a state where a functional group or partial structure selected from the above group (I) or (II) does not undergo a chemical reaction and is properly adsorbed to the solid particles while maintaining the dissolved state in the dispersion medium. Therefore, the reaggregation or sedimentation of the inorganic solid electrolyte is suppressed not only immediately after the preparation of the inorganic solid electrolyte-containing composition but also after a lapse of time, whereby a high degree of dispersibility immediately after preparation can be stably maintained (dispersion stability is excellent), and an excessive increase in viscosity can also is suppressed, whereby good fluidity can be exhibited to realize the flatness of the coating film surface (handleability is excellent).

On the other hand, in a case where a constitutional layer is formed using the inorganic solid electrolyte-containing composition according to the embodiment of the present invention, the functional group or partial structure of the soluble polymer undergoes a chemical reaction, whereby the molecular weight of the soluble polymer increases at the time of the formation of a film of a constitutional layer (for example, at the time of the application and furthermore drying of the inorganic solid electrolyte-containing composition). It is conceived that as this increase in molecular weight proceeds and a polymer binder is formed, the solubility in the dispersion medium cannot be maintained, whereby the polymer binder is solidified or precipitated, and the surface of the solid particles is partially coated (adsorbed) without being completely coated. As a result, the contact between the solid particles is not hindered by the presence of the polymer binder, and it is possible to bind the solid particles to each other while sufficiently constructing (suppressing the increase in the interface resistance between the solid particles) ion conduction paths due to the contact between the solid particles to each other.

Further, the inorganic solid electrolyte-containing composition according to the embodiment of the present invention maintains the dispersion characteristics (the dispersion stability and the handleability) even at the time of the formation of a film of a constitutional layer. As a result, it is conceived that the variation in the contact state of the solid particles in the constitutional layer is suppressed (the arrangement of the solid particles in the constitutional layer is made uniform), whereby the uniform contact (adhesion) of the solid particles can be ensured. In addition to this, a film of the inorganic solid electrolyte-containing composition is easily made, and the inorganic solid electrolyte-containing composition has proper fluidity (leveling) at the time of the film formation and becomes a constitutional layer (which is excellent in the flatness of the surface of a film to be formed) in which the surface roughness of protrusions and recesses due to insufficient fluidity or excessive fluidity as well as the surface roughness or the like due to clogging in the ejection unit at the time of the film formation does not occur. In this way, it is conceived that it is possible to realize a sheet for an all-solid state secondary battery, having a low-resistance (high-conductivity) constitutional layer having a flat surface (having a uniform layer thickness).

An all-solid state secondary battery having a constitutional layer that exhibits the above-described characteristics exhibits excellent cycle characteristics even in a case where charging and discharging are repeated under normal conditions.

By the way, in an all-solid state secondary battery for an electric vehicle, a further increase in battery resistance and a decrease in cycle characteristics is remarkable at an early stage due to high-output charging and discharging (high-speed charging and discharging) for practical application. However, the all-solid state secondary battery according to the embodiment of the present invention enables high-speed charging and discharging at a large current in addition to charging and discharging under normal conditions. Moreover, even in high-speed charging and discharging, the generation of voids due to expansion and contraction of the active material or the like is also effectively suppressed, and excellent cycle characteristics can be realized.

In a case where an active material layer is formed of the inorganic solid electrolyte-containing composition according to the embodiment of the present invention, a constitutional layer is formed while a highly (homogeneously) dispersed state immediately after preparation is maintained as described above. For this reason, it is conceived that the contact (the adhesion) of the polymer binder to the surface of the collector is not hindered by the solid particles that have been preferentially sedimented or reaggregated, and the polymer binder can come into contact with (adhesion to) the surface of the collector in a state of being dispersed together with the solid particles. As a result, in the electrode sheet for an all-solid state secondary battery in which an active material layer is formed of the inorganic solid electrolyte-containing composition according to the embodiment of the present invention on a collector, it is possible to realize strong adhesiveness between the collector and the active material. Further, the all-solid state secondary battery in which the active material layer is formed on the collector with the inorganic solid electrolyte-containing composition according to the embodiment of the present invention exhibits strong adhesiveness between the collector and the active material, and it is possible to realize the further improvement of the cycle characteristics and the conductivity.

Due to exhibiting the excellent characteristics described above, the inorganic solid electrolyte-containing composition according to the embodiment of the present invention can be preferably used a material (a constitutional layer forming material) for forming a solid electrolyte layer or an active material layer, where the material is for a sheet for an all-solid state secondary battery (including an electrode sheet for an all-solid state secondary battery) or an all-solid state secondary battery. In particular, it can be preferably used as a material for forming a negative electrode sheet for an all-solid state secondary battery or a material for forming a negative electrode active material layer, which contains a negative electrode active material having a large expansion and contraction due to charging and discharging, and high cycle characteristics and furthermore, high conductivity can be achieved in this aspect as well.

The inorganic solid electrolyte-containing composition according to the embodiment of the present invention is preferably a non-aqueous composition. In the present invention, the non-aqueous composition includes not only an aspect including no water but also an aspect where the moisture content (also referred to as the “water content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value determined by filtration through a 0.02 μm membrane filter and then by Karl Fischer titration.

The inorganic solid electrolyte-containing composition according to the aspect of the present invention includes an aspect containing not only an inorganic solid electrolyte but also an active material, as well as a conductive auxiliary agent or the like (the composition in this aspect may be referred to as the “electrode composition”).

Hereinafter, components that are contained and components that can be contained in the inorganic solid electrolyte-containing composition according to the embodiment of the present invention will be described.

<Inorganic Solid Electrolyte>

The inorganic solid electrolyte-containing composition according to the embodiment of the present invention contains an inorganic solid electrolyte.

In the present invention, the inorganic solid electrolyte is an inorganic solid electrolyte, and the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity, but the sulfide-based inorganic solid electrolytes may also include elements other than Li, S, and P depending on the purposes or cases.

Examples of the sulfide-based inorganic solid electrolyte include a lithium ion-conductive inorganic solid electrolyte satisfying the composition represented by Formula (S1).

Lₐ₁M_{b1}P_{c1}S_{d1}A_{c1} (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to el represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S-Ges₂-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolytes

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li_{(3-2xc)}M^{cc}_{xc}D^{cc}O (xe represents a number between 0 and 0.1, and M^{cc} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, It is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The particle diameter of the inorganic solid electrolyte is measured according to the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “particle diameter Analysis-Dynamic Light Scattering” as necessary. Five samples per level are produced, and the average values therefrom are employed.

One kind of inorganic solid electrolyte may be contained, or two or more kinds thereof may be contained.

In a case of forming a solid electrolyte layer, the mass (mg) (mass per unit area) of the inorganic solid electrolyte per unit area (cm²) of the solid electrolyte layer is not particularly limited. It can be appropriately determined according to the designed battery capacity and can be set to, for example, 1 to 100 mg/cm².

However, in a case where the inorganic solid electrolyte-containing composition contains an active material described later, the mass per unit area of the inorganic solid electrolyte is preferably such that the total amount of the active material and the inorganic solid electrolyte is in the above range.

The content of the inorganic solid electrolyte in the inorganic solid electrolyte-containing composition is not particularly limited. However, in terms of the binding property as well as in terms of dispersibility, it is preferably 50% by mass or more, more preferably 70% by mass or more, and still more preferably 90% by mass or more, in 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described below, regarding the content of the inorganic solid electrolyte in the inorganic solid electrolyte-containing composition, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a constitutional component other than a dispersion medium described below.

<Polymer Binder and Component Constituting the Polymer Binder>

As described above, the inorganic solid electrolyte-containing composition according to the embodiment of the present invention contains the soluble polymer defined in at least one of the following (C1) or (C2) as a constitutional component constituting a polymer binder that functions as a binder in the constitutional layer. In a case where the inorganic solid electrolyte-containing composition contains a constitutional component constituting a polymer binder, the present invention includes an aspect containing a polymer binder that is generated by the chemical reaction of the soluble polymer constituting a polymer binder in addition to an aspect containing a soluble polymer constituting a polymer binder.

(Polymer Binder)

According to the component constituting a polymer binder, at the time of the film formation of the inorganic solid electrolyte-containing composition, a functional group or partial structure (I) selected from the group (I) and a functional group or a partial structure (II) selected from the group (II) undergo a chemical reaction with each other to form a linked structure (a crosslinked structure) or the like, whereby a polymer binder is produced. The polymer binder contained in the constitutional layer, formed in this way, can be said to be a chemical reaction product of the soluble polymer defined in (C1) or (C2). Here, although the chemical structure and the like of the polymer binder to be formed are not uniquely determined depending on the kind of the functional group or the partial structure, it is preferably a chemical reaction product of a (meth)acrylic polymer or a vinyl polymer, where the details of the chemical reaction of the functional group or the partial structure will be described later. The molecular weight of the soluble polymer (the polymer binder) increases and the solubility in a dispersion medium decreases as the number of formed structures of the linked structures due to a chemical reaction, preferably an intermolecular chemical reaction. This makes it possible to effectively suppress an increase in interface resistance while maintaining the binding function between solid particles.

The polymer binder that is formed by a chemical reaction of a functional group or a partial structure has a structure in which a plurality of molecules (soluble polymers) are intricately linked, and the structure which can be adopted as a polymer binder includes a crosslinked structure (a mesh structure) or the like. However, it is difficult to adopt a core-shell type structure.

The polymer binder contained in the constitutional layer may be one kind or two or more kinds.

In a case where the constitutional layer contains a polymer binder, the present invention includes an aspect in which a constitutional component (a soluble polymer) constituting a polymer binder is contained (remained) in addition to an aspect in which a polymer binder is contained.

(Component Constituting Polymer Binder)

The component constituting a polymer binder is at least one of a combination of the following soluble polymers C1-I and C1-II defined in (C1) or the following soluble polymer C2 defined in (C2).

(C1) A combination of a polymer having at least one functional group or a partial structure, selected from the following group (I), the polymer being the soluble polymer C1-I that is dissolved in a dispersion medium contained in the inorganic solid electrolyte-containing composition, and a polymer having at least one functional group or a partial structure, selected from the following group (II), the polymer being the soluble polymer C1-II that is dissolved in a dispersion medium contained in the inorganic solid electrolyte-containing composition

In the combination of the above (C1), the functional group or partial structure (I) of the soluble polymer C1-I and the functional group or partial structure (II) of the soluble polymer C1-II undergo a chemical reaction with each other to constitute a polymer binder.

(C2) A soluble polymer C2 having each of at least one functional group or partial structure and at least one functional group or partial structure, respectively selected from the following group (I) and the following group (II)

A functional group or partial structure (I) and a functional group or partial structure (II), which are contained in the soluble polymer C2, undergo a chemical reaction with each other to constitute a polymer binder. As a result, the soluble polymer C2 can also be said to be a self-binding soluble polymer. It is preferable that soluble polymer C2 undergoes a chemical reaction with the soluble polymer C2 of another molecule.

—Group (I)—

A hydroxyl group, a primary or secondary amino group, and a 1,3-dicarbonyl structure

—Group (II)—

A blocked isocyanate group, a boronate group or borinate group, a boronic acid ester group or borinic acid ester group, and an acid anhydride structure

First, the functional groups or partial structures (I) and (II) contained in the soluble polymer will be described.

The functional group or partial structure (I) is a hydroxyl group, a primary amino group, a secondary amino group, or a 1,3-dicarbonyl structure.

In the present invention, the hydroxyl group does not include —OH constituting an acidic group such as a carboxy group.

The secondary amino group includes an imino group (—NH—) in addition to —NHR¹ (here, RI represents a substituent). The substituent which can be adopted as RI is not particularly limited, and examples thereof include a group selected from the substituent Z described later. From the viewpoint of reactivity, it is preferably an alkyl group or an aryl group, more preferably an alkyl group, and still more preferably an alkyl group having 1 to 6 carbon atoms. The imino group does not include an aspect in which an atom constituting the main chain is bonded through a carbonyl group (for example, an imino group in an amide bond that is bonded to an ethylenic unsaturated group in a (meth)acrylamide compound or the like). Further, the imino group can be introduced into a constitutional component as a polyalkylene imine chain, a polyalkylene diamine chain, or the like in combination with, for example, an alkylene group. On the other hand, it is preferable not to include the imino group contained in the imide bond (—CO—NH—CO—).

The 1,3-dicarbonyl structure means a —CO—CHR¹—CO— bond that constitutes a 1,3-dicarbonyl compound. R^{T} represents a hydrogen atom or a substituent (preferably selected from the substituent Z described later), and it is preferably a hydrogen atom in terms of reactivity. As the 1,3-dicarbonyl compound, a general compound can be used without particular limitation, and examples thereof include a 1,3-diketone compound and an acetoacetic acid compound. Examples of the 1,3-diketone compound include acetyl acetone, 3-methyl-2,4-pentanedione, trifluoroacetyl acetone, and benzoyl acetone. Examples of the acetoacetic acid compound include acetoacetic acid, an acetoacetic acid ester compound, and an acetoacetic acid amide compound. Examples of the acetoacetic acid ester compound include an acetoacetic acid ester compound having an aliphatic saturated or unsaturated hydrocarbon, an aromatic hydrocarbon, or a heterocyclic ring.

The functional group or the partial structure (I) is preferably a hydroxyl group or an amino group, it is more preferably a hydroxyl group in terms of dispersion characteristics, and it is more preferably an amino group in terms of resistance and cycle characteristics.

The functional group or the partial structure (II) is a blocked isocyanate group, a boronate group, a borinate group, a boronic acid ester group, a borinic acid ester group, or an acid anhydride structure.

The blocked isocyanate group may be any group obtained by blocking (protecting) an isocyanate group (—NCO) with a blocking agent. As the blocking agent, a compound generally used to protect an isocyanate group can be used without particular limitation, and for example, the description in JP6254185B can be referenced. Specific examples of the blocking agent include an oxime compound, a lactam compound, a phenol compound, an alcohol compound, an amine compound, an amidine compound, an active methylene compound, a pyrazole compound, a mercaptan compound, an imidazole compound, and an imide compound. Among them, it is preferably an oxime compound, lactam compound, a phenol compound, an alcohol compound, an amine compound, an amidine compound (for example, N,N′-diphenylformamidine), an active methylene compound, or a pyrazole compound, and more preferably an oxime compound or a pyrazole compound, in that the deprotection reaction proceeds under mild conditions (for example, the film forming conditions (drying temperature) described later). Examples of the oxime compound include an oxime and a ketooxime, and specific examples thereof include acetone oxime, formaldoxime, cyclohexane oxime, methyl ethyl ketone oxime, cyclohexanone oxime, and benzophenone oxime. In addition, examples of the pyrazole compound include pyrazole, methyl pyrazole, and dimethyl pyrazole.

The boronate group and the borinate group may be any group derived from boric acid (H₃BO₃). The boronate group is a group (—B(OH)₂) obtained by removing one hydroxyl group from boric acid, and the boric acid group is a group (>B(OH)) obtained by removing two hydroxyl groups from boric acid.

A boronic acid ester group is a group (—B(OR^{II})₂) in which at least one hydroxyl group of a boronate group is esterified, where two R^{II}'s each represent a hydrogen atom or a substituent, and at least one R^{II} is a substituent. The two R^{II} 's in the boronic acid ester group may be bonded to each other to form a ring structure containing an —O—B—O— bond. The borinic acid ester group is a group obtained by esterifying the hydroxyl group of the borinate group (>B(OR^{II})), where R^{II} in the borinic acid ester group represents a substituent. The substituent which can be adopted as R^{II} of each of the above ester groups is not particularly limited, and examples thereof include a group selected from the substituent Z described later. It is preferably an alkyl group or an aryl group and more preferably an alkyl group in terms of reactivity.

The acid anhydride structure may be any structure obtained by a dehydration reaction from a compound having two or more acid groups, and it is preferably a carboxylic acid anhydride structure (also referred to as a dicarboxylic acid anhydride structure, which is a linear structure containing an —CO—O—CO— bond or a ring structure).

The anhydrous carboxylic acid group is not particularly limited: however, it includes a group obtained by removing one or more hydrogen atoms from a carboxylic acid anhydride (for example, a group represented by Formula (2a)), as well as a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from a cyclic carboxylic acid anhydride. Examples thereof include acyclic carboxylic acid anhydrides such as acetic acid anhydride, propionic acid anhydride, and benzoic acid anhydride; and cyclic carboxylic acid anhydrides such as maleic acid anhydride, phthalic acid anhydride, fumaric acid anhydride, succinic acid anhydride, and itaconic acid anhydride. The polymerizable carboxylic acid anhydride is not particularly limited; however, examples thereof include a carboxylic acid anhydride having an unsaturated bond in the molecule, and a polymerizable cyclic carboxylic acid anhydride (an unsaturated carboxylic acid anhydride) is preferable. Specific examples thereof include maleic acid anhydride and itaconic acid anhydride.

Examples of the anhydrous carboxylic acid group include a group represented by Formula (2a) and a constitutional component represented by Formula (2b); however, the present invention is not limited thereto. In each of the formulae, * represents a bonding position.

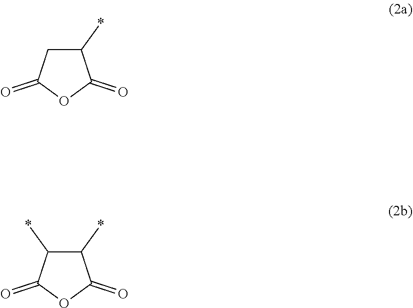 [SMILES: *C1CC(=O)OC1=O ; *C1C(=O)OC(=O)C1*]

The functional group or partial structure (II) is preferably a blocked isocyanate group or an acid anhydride structure in that the dispersion characteristics, resistance, and cycle characteristics can be improved in a well-balanced manner.

In the soluble polymer that is used in the present invention, the combination of the functional groups and the partial structures (I) and (II) are not particularly limited as long as they are selected from each group, and the combination is appropriately determined depending on the reactivity and the like. For example, it is preferably a combination of a preferred functional group or partial structure (I) and a preferred functional group or partial structure (II), and it is more preferably a combination of a hydroxyl group or amino group as the functional group or partial structure (I) and a blocked isocyanate group or acid anhydride structure as the functional group or partial structure (II).

Examples of the chemical reaction caused by a functional group or partial structure (I) and a functional group or partial structure (II) and the bond (the linking group or the crosslinking group) formed by this chemical reaction are shown below.

In a case where a hydroxyl group is selected as the functional group or partial structure (I),

it undergoes an addition reaction with a blocked isocyanate group to form a urethane bond,

it undergoes an exchange reaction, through at least one OH group, with each of a boronate group and a borinate group to form a bond with a boron atom,

it undergoes an ester exchange reaction with a boronic acid ester group and a borinic acid ester group to form a bond with a boron atom, and

it undergoes an addition reaction with an acid anhydride structure to form a carboxy group and an ester group.

In a case where a primary amino group or a secondary amino group is selected as the functional group or partial structure (I),

it undergoes an addition reaction with a blocked isocyanate group to form a urea bond,

it undergoes a dehydration reaction, through at least one OH group, with each of a boronate group and a borinate group to form a bond with a boron atom,

it undergoes a dealcoholization reaction with a boronic acid ester group and a borinic acid ester group to form a bond with a boron atom, and

it undergoes an addition reaction with an acid anhydride structure to form a carboxy group and an amide group.

In a case where a 1,3-dicarbonyl structure is selected as the functional group or partial structure (I),

it undergoes an addition reaction with a blocked isocyanate group to form a carbon-amide bond together with an α-carbon atom (a carbon atom sandwiched between two carbonyl groups) having a 1,3-dicarbonyl structure.

Regarding the reactivity between the functional groups or the partial structures, it is preferable that the chemical reaction between the functional groups or the partial structures suppress the chemical reaction at the time of the preparation of the inorganic solid electrolyte-containing composition and causes the chemical reaction at the time of the formation of a film of the inorganic solid electrolyte-containing composition. Examples of the reaction conditions include heating conditions, which are appropriately set according to the combination of functional groups or partial structures, and they can be, for example, 40° C. to 150° C.

In a case where a blocked isocyanate group is selected as the functional group or partial structure (II), the heating temperature is set according to the deprotecting temperature of the blocking agent, and it can be set, for example, 60° C. or higher, and can be set to an even higher temperature, 80° C. or higher, 100° C. or higher, or 120° C. or higher.

Next, the soluble polymer defined in (C1) will be described.

The component (C1) constituting a polymer binder is a combination of the soluble polymer C1-I having a functional group or partial structure (I) and the soluble polymer C1-II having a functional group or partial structure (II).

—Soluble Polymers C1-I and C1-II—

The soluble polymers C1-I and C1-II each may have the functional group or partial structure described above in the main chain of the polymer; however, in terms of reactivity, they preferably have it as a substituent or a linking group in the side chains and more preferably have it as a substituent at the end portion of the side chain. However, it is preferable that the acid anhydride structure is introduced into the main chain rather than the side chain.

In the present invention, a main chain of the polymer refers to a linear molecular chain in which all the molecular chains that constitute the polymer other than the main chain can be conceived as a branched chain or a pendant with respect to the main chain. Although it depends on the mass average molecular weight of the molecular chain regarded as a branched chain or pendant chain, the longest chain among the molecular chains constituting the polymer is typically the main chain. In this case, a terminal group at the polymer terminal is not included in the main chain. In addition, side chains of the polymer refer to molecular chains other than the main chain and include a short molecular chain and a long molecular chain.

In the present invention, having a functional group or a partial structure in the side chain of a polymer means that the functional group or the partial structure is directly bonded or bonded through the following linking group, to an atom constituting the main chain of the polymer.

The linking group is not particularly limited and generally includes a group other than the functional groups or partial structures (I) and (II). Specific examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P(OH)(O)—O—), and a group involved in the combination thereof. It is also possible to form a polyalkyleneoxy chain by combining an alkylene group and an oxygen atom.

The linking group is preferably a group composed of a combination of an alkylene group, an arylene group, a carbonyl group, an oxygen atom, a sulfur atom, and an imino group, more preferably a group composed of a combination of an alkylene group, an arylene group, a carbonyl group, an oxygen atom, and an imino group, still more preferably a group containing a —CO—O— group, a —CO—N(R^{N})— group (here, R^{N} is as described above), or an arylene group, and particularly preferably a —CO—O-alkylene group, a —CO—N(R^{N})-alkylene group, a —CO—O-alkylene-O— group, a —CO—N(R^{N})-alkylene-O— group, a phenylene group, or a phenylene-alkylene-O-group.

In the present invention, the number of atoms forming the linking group is preferably 1 to 36, more preferably 1 to 24, and still more preferably 1 to 12. The number of linking atoms of the linking group is preferably 10 or less and more preferably 8 or less. The lower limit thereof is 1 or more. The number of linking atoms refers to the minimum number of atoms linking predetermined structural parts. For example, in a case of —CH₂—C(═O)—O—, the number of atoms that constitute the linking group is 6; however, the number of linking atoms is 3.

It suffices that the soluble polymers C1-I and C1-II each have at least one kind of functional group or partial structure (I) or (II), and it may have a plurality of kinds, for example, 2 to 4 kinds.

It suffices that the soluble polymer has at least one functional group or at least one partial structure (I) or (II), and it preferably has a plurality thereof regardless of the number of kinds in that the solubility of the soluble polymer due to the chemical reaction is effectively reduced. In the present invention, the number of functional groups or partial structures contained in one molecule of the soluble polymer is not unique depending on the composition of the soluble polymer and the like; however, it is appropriately determined depending on the number of functional groups or partial structures, contained in the reactive constitutional components described later, the content of the reactive constitutional component, and the like.

In (C1), the combination of the functional group or partial structure (I) of the soluble polymer C1-I and the functional group or partial structure (II) of the soluble polymer C1-II is not particularly limited and is appropriately set. For example, it is preferably a combination of a preferred functional group or partial structure (I) and a preferred functional group or partial structure (II), and it is more preferably a combination of a hydroxyl group or amino group as the functional group or partial structure (I) and a blocked isocyanate group or acid anhydride structure as the functional group or partial structure (II).

The soluble polymer C1-I may have a functional group or partial structure (II) capable of reacting with the functional group or partial structure (I) as long as the solubility of the soluble polymer C1-I is not impaired. The soluble polymer C1-II may also have a functional group or partial structure (I).

The soluble polymers C1-I and C1-II each exhibit solubility (solubleness) in a dispersion medium contained in the inorganic solid electrolyte-containing composition, and it is dissolved in a dispersion medium in the inorganic solid electrolyte-containing composition. This makes it possible to enhance the dispersion characteristics of the inorganic solid electrolyte-containing composition.

In the present invention, the description that the polymer is dissolved in the dispersion medium means, for example, that the solubility is 80% or more in the solubility measurement. The measuring method for solubility is as follows.

That is, a specified amount of a polymer to be measured is weighed in a glass bottle, 100 g of a dispersion medium that is the same kind as the dispersion medium contained in the inorganic solid electrolyte-containing composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the polymer dissolved (the above-described specified amount), and the upper limit concentration X (% by mass) at which the transmittance is 99.8% is defined as the solubility of the polymer in the above dispersion medium.

The solubility of the polymer can be adjusted depending on the kind or composition of the polymer (the kind or content of the constitutional component), mass average molecular weight, and the like.

—Transmittance Measurement Conditions—
Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

Regarding the soluble polymers C1-I and C1-II, a combination obtained by combining polymers of the same kinds or different from each other or compositions can be adopted. It is preferably a combination between chain polymerization polymers described below, more preferably a combination in which at least one polymer is a (meth)acrylic polymer or a vinyl polymer, still more preferably a combination in which both polymers are (meth)acrylic polymers or vinyl polymers, even still more preferably a combination between both polymers of (meth)acrylic polymers, or a combination in which the soluble polymer C1-I is a vinyl polymer and the soluble polymer C1-II is a (meth)acrylic polymer, and particularly preferably a combination in which the soluble polymer C1-I is a vinyl polymer and the soluble polymer C1-II is a (meth)acrylic polymer.

As each of the soluble polymers C1-I and C1-II, a commercially available product or a synthesized product may be used.

The content of the soluble polymers C1-I and C1-II in the inorganic solid electrolyte-containing composition is not particularly limited; however, it is appropriately considered in consideration of the number of functional groups or partial structures of each soluble polymer.

Focusing on the number of functional groups or partial structures of the soluble polymer, the ratio of the functional group or partial structure (I) to the functional group or partial structure (II) [the functional group or partial structure (I):the functional group or partial structure (II)] is ideally 1:1. However, in the present invention, it can be set to 1:0.01 to 1:10, and it is preferably 1:0.05 to 1:5 and more preferably 1:0.1 to 1:2 in terms of dispersion characteristics, resistance, and cycle characteristics.

On the other hand, focusing on the mass of the soluble polymer, each of the contents of the soluble polymer C1-I and the soluble polymer C1-11 in the inorganic solid electrolyte-containing composition is not particularly limited. However, in terms of improvement in dispersion characteristics, resistance, cycle characteristics, and the like, it is preferably 0.1% to 9.9% by mass, more preferably 0.15% to 3.5% by mass, still more preferably 0.25% to 2.5% by mass, and particularly preferably 0.25% to 1.5% by mass, in 100% by mass of the solid content.

The total content of the soluble polymer C1-I and the soluble polymer C1-II is appropriately set in a range where the above content is satisfied. However, in terms of improvement in dispersion characteristics, resistance, cycle characteristics, and the like, it is preferably 0.1% to 10.0% by mass, more preferably 0.3% to 7.0% by mass, still more preferably 0.5% to 5.0% by mass, and particularly preferably 0.5% to 3.0% by mass, in 100% by mass of the solid content. In addition, the mass ratio of the content of the soluble polymer C1-I to the content of the soluble polymer C1-11 [the content of the soluble polymer C1-1:the content of the soluble polymer C1-II] is appropriately set in a range where the content of each of the above soluble polymers is satisfied. However, in terms of improvement in dispersion characteristics, resistance, cycle characteristics, and the like, it is not particularly limited, and for example, it is preferably 1:10 to 10:1, more preferably 1:5 to 5:1, and still more preferably 1:3 to 3:1.

The above contents of the soluble polymers C1-I and C1-II are the total amount including a content of a soluble polymer which has undergone a chemical reaction in a case where the soluble polymers C1-I and C1-II have undergone a chemical reaction with the other soluble polymer C1-II or C1-I.

Next, the component (C2) constituting a polymer binder will be described.

The soluble polymer C2 has at least one functional group or partial structure (I) and at least one functional group or partial structure (II).

The functional group or partial structure (I) and (II) contained in the soluble polymer C2, and further, the aspect having this functional group or partial structure in the side chain are respectively the same as those in the soluble polymers C1-I and C1-II.

It suffices that the soluble polymer C2 has at least one kind of functional group or at least one kind of partial structure (I) and (II), and it may have a plurality of kinds, for example, 2 to 4 kinds.

Further, it suffices that the soluble polymer C2 has at least one functional group or at least one partial structure (I) and (II), and it preferably has a plurality thereof regardless of the number of kinds in that the solubility of the soluble polymer C2 due to the chemical reaction is effectively reduced. In the present invention, each of the numbers of functional groups and partial structures (I) and (II) contained in one molecule of the soluble polymer C2 is not unique depending on the composition of the soluble polymer and the like, and it is appropriately determined similarly to the soluble polymer C1-I and the like.

The combination of the functional groups or partial structures (I) and (II), contained in the soluble polymer C2, is not particularly limited and is appropriately set. Examples thereof include the preferred above-described combination of the functional group or partial structure (I) and (II) in the above (C1).

The soluble polymer C2 exhibits solubility in a dispersion medium contained in the inorganic solid electrolyte-containing composition, and it is dissolved in a dispersion medium in the inorganic solid electrolyte-containing composition. This makes it possible to enhance the dispersion characteristics of the inorganic solid electrolyte-containing composition. In the present invention, the description that the soluble polymer C2 is dissolved in a dispersion medium is synonymous with the description that the soluble polymer C1-I or the like is dissolved in a dispersion medium as described above, except that the polymer is different.

The soluble polymer C2 is preferably a chain polymerization polymer described later, more preferably a (meth)acrylic polymer or a vinyl polymer, still more preferably a vinyl polymer, and particularly preferably a vinyl polymer having a constitutional component derived from a styrene compound.

As each of the soluble polymer C2, a commercially available product or a synthesized product may be used.

The inorganic solid electrolyte-containing composition according to the embodiment of the present invention may contain one or more soluble polymers C2.

In the soluble polymer C2, the abundance ratio of the functional group or partial structure (I) to the functional group or partial structure (II) in the polymer is not particularly limited; however, it is appropriately determined in consideration of, for example, the number of functional groups or partial structures contained in each soluble polymer. Focusing on the number of functional groups or partial structures of the soluble polymer, the ratio of the functional group or partial structure (I) to the functional group or partial structure (II) [the functional group or partial structure (I):the functional group or partial structure (II)] is set in the same range as the ratio of the soluble polymers C1-I and C1-11 described above. The content of the soluble polymer C2 in the inorganic solid electrolyte-containing composition is not particularly limited; however, it is preferably 0.1% to 10.0% by mass, more preferably 0.3% to 7.0% by mass, still more preferably 0.5% to 5.0% by mass, and particularly preferably 0.5% to 3.0% by mass, in 100% by mass of the solid content. The above content of the soluble polymer C2 is the total amount including a content of the soluble polymer C2 which forms this chemical reaction in a case where the soluble polymers C2 have undergone a chemical reaction with each other.

—Soluble Polymers C1-I, C1-II, and C2 —

The soluble polymers C1-1, C1-II, and C2 are the same except for the above-described functional group or partial structure contained in the molecule, and thus they will be described together.

The soluble polymer is not particularly limited as long as it has the above-described functional group or partial structure and exhibits solubility in a dispersion medium, and a polymer that is generally used as a binding agent for an all-solid state secondary battery can be used without particular limitation. Specific examples of the polymer constituting a soluble polymer include sequential polymerization (polycondensation, polyaddition, or addition-condensation) polymers such as polyurethane, polyurea, polyamide, polyimide, polyester, polyether, and polycarbonate, as well as chain polymerization polymer such as a fluorine polymer (a fluorine-containing polymer), a hydrocarbon polymer, a vinyl polymer, and a (meth)acrylic polymer. Among them, a vinyl polymer or a (meth)acrylic polymer is preferable.

The polymer constituting the soluble polymers C1-1, C1-II, and C2 are each preferably a chain polymerization polymer. Among the above, it is preferably a polymer (a (meth)acrylic polymer or a vinyl polymer) having 50% by mass or more of a constitutional component in the polymer, where the constitutional component is derived from a (meth)acrylic monomer or vinyl monomer.

In the present invention, in a case where the polymer is a copolymer, the bonding mode (the arrangement) of the copolymerization component is not particularly limited, and the copolymer may be any one of a random copolymer, an alternating copolymer, a block copolymer, a graft copolymer, or the like.

The (meth)acrylic monomer includes a monomer having a (meth)acryloyloxy group or a (meth)acryloylamino group, as well as a (meth)acrylonitrile compound and the like. The (meth)acrylic monomer is not particularly limited; however, examples thereof include (meth)acrylic compounds (M) such as a (meth)acrylic acid compound, a (meth)acrylic acid ester compound, a (meth)acrylamide compound, and a (meth)acrylonitrile compound, as well as a (meth)acrylic compound having a plurality of imino groups as a secondary amino group (for example, a (meth)acrylic compound having a polyethyleneimine chain). Among them, a (meth)acrylic acid ester compound is preferable. The (meth)acrylic acid ester compound is not particularly limited; however, examples thereof include an ester of a heterocyclic compound such as an aliphatic or aromatic hydrocarbon, an aliphatic or aromatic heterocyclic compound, where an aliphatic hydrocarbon, particularly an alkyl group is preferable. The number of carbon atoms of these hydrocarbons, heterocyclic compounds, and the like, and the kind or number of heteroatoms are not particularly limited and are appropriately set. For example, the number of carbon atoms can be 1 to 30.

The vinyl monomer is a monomer containing a vinyl group other than the (meth)acrylic compound (M), and it is not particularly limited. Examples thereof include vinyl group-containing aromatic compounds (a styrene compound, a vinyl naphthalene compound, and the like); vinyl group-containing heterocyclic compounds (a vinyl group-containing aromatic heterocyclic compound such as a vinyl carbazole compound, a vinyl pyridine compound, a vinyl imidazole compound, or N-vinylcaprolactam, a vinyl group-containing non-aromatic heterocyclic compound, and the like); and vinyl compounds such as an allyl compound, a vinyl ether compound, a vinyl ketone compound, a vinyl ester compound, a dialkyl itaconate compound, an unsaturated carboxylic acid anhydride, and the like. Examples of the vinyl compound include the “vinyl monomer” disclosed in JP2015-88486A.

Among the (meth)acrylic acid ester compounds, the soluble polymer preferably has, as a (meth)acrylic monomer, a constitutional component derived from a (meth)acrylic acid ester compound of an aliphatic hydrocarbon (preferably alkyl) having 4 or more carbon atoms in terms of the exhibition and improvement of solubility in a dispersion medium. The aliphatic hydrocarbon group preferably has 6 or more carbon atoms and more preferably 10 or more carbon atoms. The upper limit thereof is not particularly limited, and it is preferably 20 or less and more preferably 14 or less. The aliphatic hydrocarbon having 4 or more carbon atoms may have a branched chain structure or a cyclic structure, where a linear structure is preferable.

In terms of resistance and cycle characteristics as well as the improvement of the hardness of the polymer binder, the soluble polymer preferably has, as a vinyl monomer, a constitutional component derived from a styrene compound, and it more preferably has at least one of a constitutional component derived from a (meth)acrylic monomer or a constitutional component derived from a vinyl monomer other than a styrene compound and has a constitutional component (a styrene constitutional component) derived from a styrene compound.

Further, in terms of resistance and cycle characteristics, the soluble polymer preferably has, as a vinyl monomer, a constitutional component derived from an unsaturated carboxylic acid anhydride and more preferably has a constitutional component derived from maleic acid anhydride.

The soluble polymer may have another copolymerizable constitutional component.

The functional group or the partial structure (I) and (II) may be introduced into any constitutional component as long as it is a constitutional component constituting a soluble polymer. However, it is preferably introduced into a constitutional component derived from a (meth)acrylic monomer or vinyl monomer (preferably a styrene compound), as well as a constitutional component derived from a hydrocarbon polymer described later or the like. The (meth)acrylic monomer into which the functional group or the partial structure (I) and (II) is introduced is preferably a (meth)acrylic acid ester compound, more preferably an alkyl ester compound of (meth)acrylic acid, having 1 to 6 carbon atoms, and still more preferably an alkyl ester compound of (meth)acrylic acid, having 1 to 3 carbon atoms. Further, it is also preferable that a constitutional component derived from the above-described unsaturated carboxylic acid anhydride is contained as the vinyl monomer and an acid anhydride structure is contained in the main chain as the functional group or partial structure (for example, a constitutional component represented by Formula (2b)).

In the soluble polymer C2, the functional groups or partial structures (I) and (II) may be introduced into the same constitutional components. However, they are preferably introduced into constitutional components different from each other in that the chemical reaction proceeds rapidly and in terms of dispersion characteristics, resistance, and cycle characteristics.

In the present invention, in a case where the constitutional component, into which the functional group or partial structure (I) or (II) is introduced, is distinguished from a constitutional component into which the functional groups or partial structure (I) and (II) are not introduced, it is referred to as, for convenience, a reactive constitutional component.

Specific examples of the constitutional component having a functional group or partial structure (I) and the constitutional component having a functional group or partial structure (II) are shown below; however, the present invention is not limited thereto. In the following specific examples, Bu indicates normal butyl, Ph indicates phenyl, iPr indicates isopropyl, and n is an integer of 1 to 50.

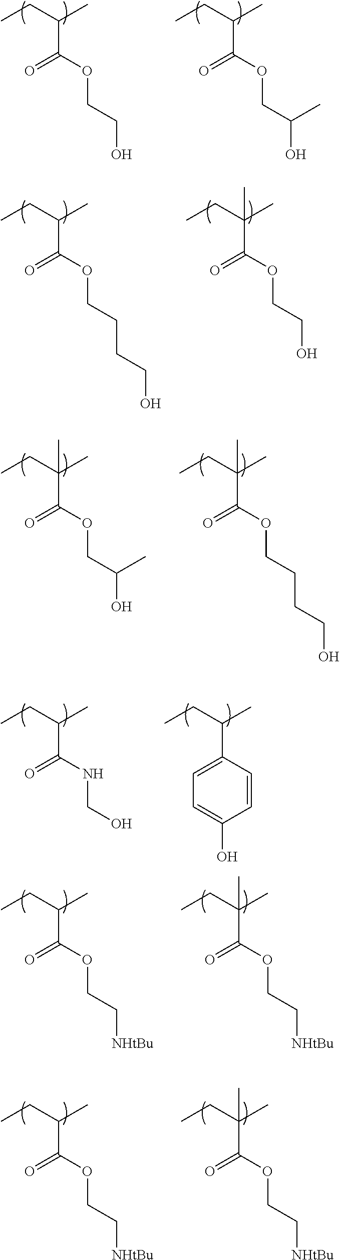

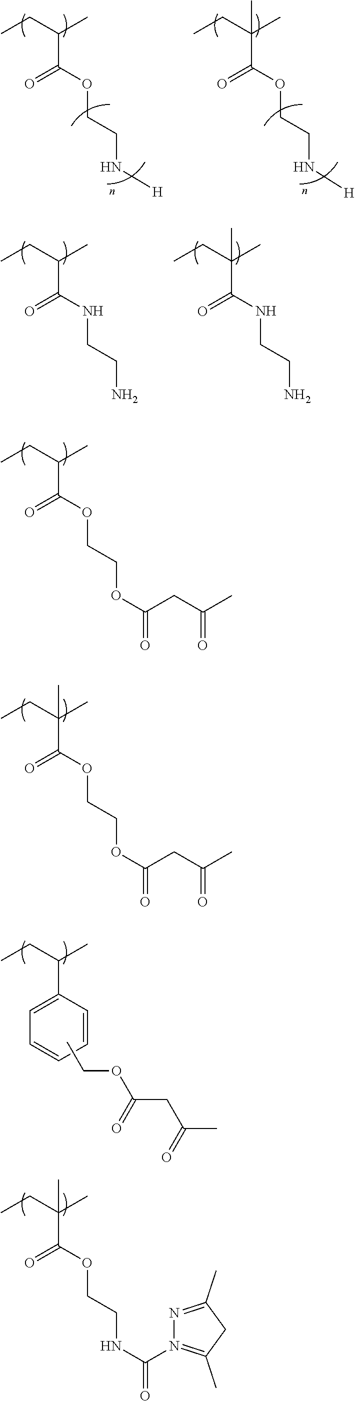

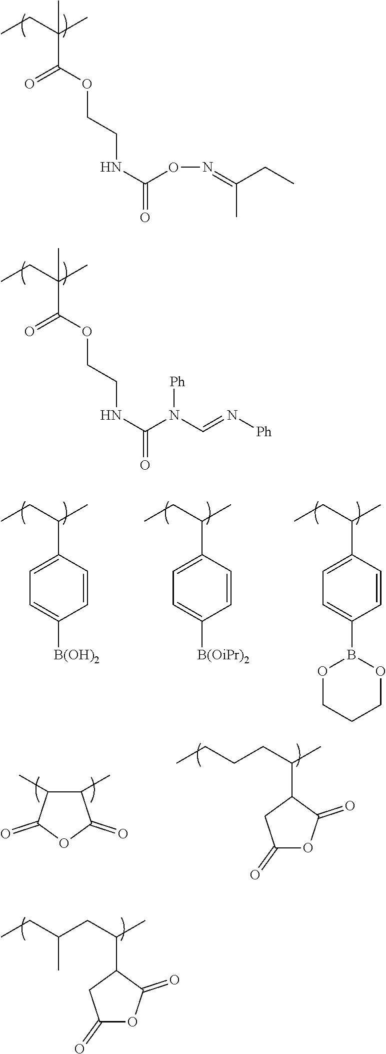

The vinyl polymer more preferably used as a soluble polymer is not particularly limited, and examples thereof include a polymer containing a constitutional component derived from a vinyl monomer other than the (meth)acrylic compound (M), for example, by 50% by mass or more. Examples of the vinyl monomer include vinyl compounds described above. The vinyl polymer includes polyvinyl alcohol, polyvinyl acetal, polyvinyl acetate, and a copolymer containing these.

The vinyl polymer preferably has a constitutional component derived from a vinyl monomer and a reactive constitutional component and may further have a constitutional component derived from a (meth)acrylic compound (M) that forms a (meth)acrylic polymer described later, which will be described later, and a constitutional component (MM) derived from a macromonomer, which will be described later.

The content of the constitutional components in the vinyl polymer is not particularly limited, and it is appropriately selected in consideration of solubility in a dispersion medium and the like. For example, it can be set in the following range, in 100% by mass of all the constitutional components.

The content of the constitutional component derived from a vinyl monomer is preferably the same as the content of the constitutional component derived from the (meth)acrylic compound (M) in the (meth)acrylic polymer in terms of dispersion characteristics as well as resistance and cycle characteristics. In the vinyl polymer, the content of the constitutional component derived from a styrene compound among the vinyl monomers (in a case where the reactive constitutional component corresponds to this constitutional component as well, the content of the reactive constitutional component is added up together; the same shall apply hereinafter) is appropriately set in consideration of the range of the content of the constitutional component derived from a vinyl monomer. However, in terms of resistance and cycle characteristics, it is preferably 30% to 85% by mass, more preferably 40% to 80% by mass, and still more preferably 50% to 75% by mass. In addition, in the vinyl polymer, the content of the constitutional component derived from an unsaturated carboxylic acid anhydride among the vinyl monomers is appropriately set in consideration of the range of the content of the constitutional component derived from a vinyl monomer. However, in terms of resistance and cycle characteristics, it is preferably 0.1% to 10% by mass, more preferably 0.3% to 7% by mass, and still more preferably 2% to 5% by mass.

The content of the reactive constitutional component in the vinyl polymer is appropriately determined in consideration of the content of a constitutional component derived from the vinyl monomer described above or a (meth)acrylic compound (M) described later. For example, the content thereof in each of the soluble polymers C1-I and C1-II is preferably 0.1% to 40% by mass, more preferably 1% to 30% by mass, and particularly preferably 2% to 25% by mass, in terms of dispersion characteristics, resistance, and cycle characteristics. On the other hand, the content thereof in the soluble polymer C2 is preferably 0.1% to 50% by mass, more preferably 5% to 40% by mass, and particularly preferably 10% to 30% by mass, in terms of the same points as above.

The content of the constitutional component derived from the (meth)acrylic compound (M) (in a case where the reactive constitutional component corresponds to this constitutional component as well, the content of the reactive constitutional component is added up together; the same shall apply hereinafter) is not particularly limited. However, it is preferably 1% to 90% by mass, more preferably 10% to 70% by mass, and still more preferably 25% to 50% by mass. In the vinyl polymer, the content of the constitutional component derived from the (meth)acrylic acid ester compound of the aliphatic hydrocarbon having 4 or more carbon atoms, among the (meth)acrylic compounds (M), is appropriately set in consideration of the range of the content of the constitutional component derived from the (meth)acrylic compound (M). For example, it is preferably 5% to 95% by mass, more preferably 8% to 50% by mass, and still more preferably 10% to 30% by mass.

The content of the constitutional component (MM) is preferably the same as the content in the (meth)acrylic polymer.

In a case where another constitutional component is contained, the content thereof is appropriately determined.

The (meth)acrylic polymer that is more preferably used as a soluble polymer is not particularly limited; however, it is, for example, preferably a polymer obtained by (co)polymerizing at least one (meth)acrylic compound (M) described above. Further, a (meth)acrylic polymer consisting of a copolymer of the (meth)acrylic compound (M) and another polymerizable compound (N) is also preferable. The other polymerizable compound (N) is not particularly limited, and examples thereof include the above-described vinyl compound. Examples of the (meth)acrylic polymer include a polymer containing a constitutional component derived from the (meth)acrylic compound (M) by 50% by mass or more. For example, the aspect of the (meth)acrylic polymer includes an aspect in which the above-described constitutional component derived from a monomer having a low molecular weight (not having a polymerized chain) is contained and a constitutional component derived from the macromonomer (MM) having a polymerized chain is not contained, and an aspect in which the constitutional component (MM) is contained. This macromonomer is not particularly limited; however, examples thereof include a (meth)acrylic monomer or a vinyl monomer, which has a polymerized chain having the number average molecular weight of 1,000 or more, and specific examples thereof include the macromonomer (X) disclosed in JP2015-088486A. Examples of the (meth)acrylic polymer include those described in JP6295332B.

The content of the constitutional components in the (meth)acrylic polymer is not particularly limited, and it is appropriately selected in consideration of solubility in a dispersion medium and the like. For example, it can be set in the following range, in 100% by mass of all the constitutional components.

The content of the constitutional component derived from the (meth)acrylic compound (M), in the (meth)acrylic polymer, is not particularly limited and can be 100% by mass. However, In terms of dispersion characteristics as well as resistance and cycle characteristics, it is preferably 5% to 90% by mass, more preferably 10% to 80% by mass, still more preferably 20% to 70% by mass, and particularly preferably more than 50% by mass and 70% by mass or less. In addition, in the (meth)acrylic polymer, the content of the constitutional component derived from the (meth)acrylic acid ester compound of the aliphatic hydrocarbon having 4 or more carbon atoms is appropriately set in consideration of the range of the content of the constitutional component derived from the (meth)acrylic compound (M). For example, it is preferably 20% to 98% by mass, more preferably 50% to 95% by mass, and still more preferably 60% to 90% by mass.

The content of the reactive constitutional component in the (meth)acrylic polymer is appropriately determined in consideration of the content of the (meth)acrylic compound (M) or the vinyl monomer described later. For example, the content thereof in each of the soluble polymers C1-I and C1-II is preferably 0.1% to 50% by mass, more preferably 1% to 40% by mass, and particularly preferably 2% to 35% by mass, in terms of dispersion characteristics, resistance, and cycle characteristics. On the other hand, the content thereof in the soluble polymer C2 is preferably 0.1% to 50% by mass, more preferably 5% to 40% by mass, and particularly preferably 10% to 35% by mass, in terms of the same points as above. The content of the constitutional component derived from the polymerizable compound (N), in the (meth)acrylic polymer, is not particularly limited. However, it is preferably 1% by mass or more and less than 50% by mass, more preferably 5% by mass or more and 50% by mass or less, and particularly preferably 20% by mass or more and less than 50% by mass. In the (meth)acrylic polymer, the content of the constitutional component derived from a styrene compound, among the polymerizable compounds (N), is appropriately set in consideration of the range of the content of the constitutional component derived from the polymerizable compound (N). However, In terms of resistance and cycle characteristics, it is preferably 1% by mass or more and less than 50% by mass, more preferably 10% to 45% by mass, and still more preferably 20% to 40% by mass. Further, in the (meth)acrylic polymer, the content of the constitutional component derived from an unsaturated carboxylic acid anhydride among the vinyl monomers is appropriately set in consideration of the range of the content of the constitutional component derived from a vinyl monomer. However, in terms of resistance and cycle characteristics, it is preferably 0.1% to 10% by mass, more preferably 0.3% to 7% by mass, and still more preferably 2% to 5% by mass.

The content of the component (MM) is preferably 5% to 70% by mass and more preferably 20% to 50% by mass.

In a case where another constitutional component is contained, the content thereof is appropriately determined.

The hydrocarbon polymer that is preferably used as a soluble polymer is not particularly limited. However, it generally includes a (co)polymerization polymer of α-olefin. Specific examples thereof include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and a hydrogen-added (hydrogenated) polymer thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-isobutylene-styrene block copolymer (SIBS), a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and as well as a random copolymer corresponding to each of the above-described block copolymers.

The content of the constitutional component in the hydrocarbon polymer is not particularly limited and is appropriately selected in consideration of solubility in a dispersion medium and the like.

In a case where the hydrocarbon polymer has a constitutional component derived from a styrene compound, the content of this constitutional component in the hydrocarbon polymer is, for example, preferably 1% to 70% by mass, more preferably 10% to 50% by mass, and particularly preferably 20% to 40% by mass, in terms of resistance and cycle characteristics.

In addition, in a case where the hydrocarbon polymer has a constitutional component derived from an unsaturated carboxylic acid anhydride, the content of this constitutional component in the hydrocarbon polymer is, for example, preferably 0.1% to 20% by mass, more preferably 0.2% to 15% by mass, and particularly preferably 0.3% to 10% by mass, in terms of resistance and cycle characteristics.

Examples of the fluorine polymer that is preferably used as a soluble polymer include a (co)polymerization polymer such as a polymerizable compound substituted fluorine. Specific examples thereof include polytetrafluoroethylene (PTFE), polyvinylidene difluoride (PVdF), a copolymer of polyvinylidene difluoride and hexafluoropropylene (PVdF-HFP), and a copolymer (PVdF-HFP-TFE) of polyvinylidene difluoride, hexafluoropropylene, and tetrafluoroethylene.

The content of the constitutional component in the fluorine polymer is not particularly limited and is appropriately selected in consideration of solubility in a dispersion medium and the like.

For example, in PVdF-HFP, the copolymerization ratio [PVdF:HFP] (mass ratio) of PVdF to HFP is not particularly limited; however, it is preferably 9:1 to 4:6 and more preferably 9:1 to 7:3 from the viewpoint of adhesiveness. In addition, in PVdF-HFP-TFE, the copolymerization ratio [PVdF:HFP:TFE] (mass ratio) of PVdF, HFP, and TFE is not particularly limited; however, it is preferably 20 to 60:10 to 40: 5 to 30.

In a case where the fluorine polymer has a constitutional component derived from the (meth)acrylic compound (M), the content of this constitutional component in the fluorine polymer is preferably 0.1% to 40% by mass, more preferably 1% to 30% by mass, and particularly preferably 3% to 20% by mass, in terms of resistance and cycle characteristics.

The soluble polymer may have a substituent. The substituent is not particularly limited; however, examples thereof preferably include a group selected from the following substituent Z.

Since the polymer binder composed of the soluble polymer has a function of binding solid particles as described above, the soluble polymer may have a substituent (for example, a polar group such as a carboxy group) which exhibits adsorptivity to the solid particles.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; in the present specification, the aryloxy group has a meaning including an aryloyloxy group therein when being referred to); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which an —O—CO— group is bonded to the above heterocyclic group); an amino group (preferably an amino group having 0 to 20 carbon atoms, an alkylamino group, or an arylamino group, for example, an amino (—NH2) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, a benzoyloxy group, a naphthoyloxy group, or a nicotinoyloxy group); an aryloyloxy group (preferably an aryloyloxy group having 7 to 23 carbon atoms, for example, a benzoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphate group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂) a sulfo group (a sulfonate group), a hydroxy group, a sulfanyl group, a carboxy group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

(Physical Properties or Characteristics of Soluble Polymer and Like)

The soluble polymer preferably has the following physical properties or characteristics.

The water content of the soluble polymer is preferably 100 ppm (mass basis) or lower. Further, as this soluble polymer, a polymer may be crystallized and dried, or a soluble polymer solution may be used as it is.

The soluble polymer is preferably noncrystalline. In the present invention, the description that a polymer is “noncrystalline” typically refers to that no endothermic peak due to crystal melting is observed when the measurement is carried out at the glass transition temperature.

The soluble polymer may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the range described below at the start of use of the all-solid state secondary battery.

The mass average molecular weight of the soluble polymer is not particularly limited. It is, for example, preferably 15,000 or more, more preferably 30,000 or more, and still more preferably 50,000 or more. The upper limit thereof is practically 5,000,000 or less, preferably 4,000,000 or less, more preferably 3,000,000 or less, and still more preferably 500,000 or less. It can be 300,000 or less, and further, it can be 100,000 or less.

—Measurement of Molecular Weight—

In the present invention, unless specified otherwise, molecular weights of a polymer chain and a macromonomer refer to a mass average molecular weight and number average molecular weight in terms of standard polystyrene conversion, which are determined according to gel permeation chromatography (GPC. The measurement method thereof includes, basically, a method under Conditions 1 or Conditions 2 (preferential) described below. However, depending on the kind of polymer or macromonomer, an appropriate eluent may be appropriately selected and used.

(Conditions 1)

Column: Connect two TOSOH TSKgel Super AWM-H (product name, manufactured by Tosoh Corporation)

Carrier: 10 mM LiBr/N-methylpyrrolidone

Measurement temperature: 40° C.

Carrier flow rate: 1.0 ml/min

Sample concentration: 0.1% by mass

Detector: refractive indicator (RI) detector

(Conditions 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)

Carrier: tetrahydrofuran

Measurement temperature: 40° C.

Carrier flow rate: 1.0 ml/min

Sample concentration: 0.1% by mass

Detector: refractive indicator (RI) detector

The soluble polymer can be synthesized by selecting a raw material compound and polymerizing the raw material compound (the monomer) by a known method. The method of incorporating a functional group or a partial structure is not particularly limited, and examples thereof include a method of copolymerizing a compound having a functional group or a partial structure, a method of using a polymerization initiator having (generating) a functional group or a partial structure or a chain transfer agent, and a method of using a polymeric reaction.

Specific examples of the soluble polymer include those exemplified in Examples; however, the present invention is not limited thereto.

The inorganic solid electrolyte-containing composition according to the embodiment of the present invention may contain a component constituting one kind of polymer binder or may contain a component constituting a plurality of kinds of polymer binders.

The content of the component constituting a polymer binder, in the inorganic solid electrolyte-containing composition, is as described above. However, in a case of assuming that this component forms a polymer binder, the content of the polymer binder in the inorganic solid electrolyte-containing composition is preferably 0.1% to 10.0% by mass, more preferably 0.2% to 5.0% by mass, and still more preferably 0.3% to 4.0% by mass, with respect to the total mass of the composition in terms of dispersion characteristics, resistance, and cycle characteristics. On the other hand, for the same reason as above, it is preferably 0.1% to 10.0% by mass, more preferably 0.3% to 8% by mass, and still more preferably 0.5% to 7% by mass, with respect to 100% by mass of the solid content.

In the present invention, the mass ratio [(the mass of the inorganic solid electrolyte+the mass of the active material)/(the mass of the polymer binder)] of the total content of the inorganic solid electrolyte and the active material to the content of the polymer binder in 100% by mass of the solid content is preferably in a range of 1,000 to 1. Furthermore, this ratio is more preferably 500 to 2 and still more preferably 100 to 10.

<Dispersion Medium>

The inorganic solid electrolyte-containing composition according to the embodiment of the present invention preferably contains a dispersion medium for dispersing each of the above components.

It suffices that the dispersion medium is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersion characteristics can be exhibited. The non-polar dispersion medium generally refers to a dispersion medium having a property of a low affinity to water; however, in the present invention, examples thereof include an ester compound, a ketone compound, an ether compound, an aromatic compound, and an aliphatic compound. Among them, preferred examples thereof include a ketone compound, an aliphatic compound, and an ester compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, and xylene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, butyl acetate, propyl acetate, propyl butyrate, isopropyl butyrate, butyl butyrate, isobutyl butyrate, butyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

In terms of the dispersion characteristics, the dispersion medium preferably has an SP value (unit: MPa^{1/2}) of 10.0 to 30.0, more preferably 15.0 to 25.0, and still more preferably 17.0 to 20.0.

The SP value of the dispersion medium is defined as a value obtained by converting the SP value calculated according to the following Hoy method into the unit of MPa^{1/2}. In a case where the inorganic solid electrolyte-containing composition contains two or more kinds of dispersion media, the SP value of the dispersion medium means the SP value of the entire dispersion media, and it is the sum of the products of the SP values and the mass fractions of the respective dispersion media. Specifically, the calculation is carried out in the same manner as the above-described method of calculating the SP value of the polymer, except that the SP value of each of the dispersion media is used instead of the SP value of the constitutional component.

The SP values (unit is omitted) of the dispersion media are shown below.

MIBK (18.4), diisopropyl ether (16.8), dibutyl ether (17.9), diisopropyl ketone (17.9), DIBK (17.9), butyl butyrate (18.6), butyl acetate (18.9), toluene (18.5), ethylcyclohexane (17.1), cyclooctane (18.8), isobutyl ethyl ether (15.3), N-methylpyrrolidone (NMP, SP value: 25.4)

The SP value of the dispersion medium is a value determined according to the Hoy method (see H. L. Hoy JOURNAL OF PAINT TECHNOLOGY, Vol. 42, No. 541, 1970, 76-118, and POLYMER HANDBOOK 4^{th}, Chapter 59, VII, page 686, Table 5, Table 6, and the following formula in Table 6) is converted to the SP value (MPa^{1/2}) (for example, 1 cal^{1/2} cm^{-3/2}≈2.05 J^{1/2} cm^{-3/2}≈2.05 MPa^{1/2}) and used.

$${δ}_{t} = \frac{{F}_{t} + \frac{B}{\overline{n}}}{V} : B = 277$$

In the expression, δₜ indicates an SP value. Ft is a molar attraction function (J×cm³)^{1/2}/mol and represented by the following expression. V is a molar volume (cm³/mol) and represented by the following expression. n̅ is represented by the following expression.

$$\begin{matrix}{F}_{t} = \sum {n}_{i} {F}_{t , i} & V = \sum {n}_{i} {V}_{i} \\ \overline{n} = \frac{0.5}{{Δ}_{T}^{( P )}} & {Δ}_{T}^{( P )} = \sum {n}_{i} {Δ}_{T , i}^{( P )}\end{matrix}$$

In the above formula, F_{t,i} indicates a molar attraction function of each constitutional unit, Vᵢ indicates a molar volume of each constitutional unit, Δ^{(P)}_{T,i} indicates a correction value of each constitutional unit, and nᵢ indicates the number of each constitutional unit.

In terms of dispersion characteristics, the dispersion medium preferably has a C Log P value of −2.5 or more, more preferably −0.5 or more, still more preferably 2.0 or more, and particularly preferably 2.6 or more, where the C Log P value is calculated according to the above method. The upper limit thereof is not particularly limited; however, it is practically 10.0 or less and preferably 5.0 or less.

The C Log P value of the dispersion medium is indicated in parentheses.

Toluene (2.5), xylene (3.12), hexane (3.9), heptane (Hep, 4.4), octane (4.9), cyclohexane (3.4), cyclooctane (4.5), decalin (4.8), diisobutyl ketone (3.0), dibutyl ether (2.57), butyl butyrate (2.8), tributylamine (4.8), methyl isobutyl ketone (1.31), ethylcyclohexane (3.4)

The dispersion medium preferably has a boiling point of 50° C. or higher and more preferably 70° C. or higher at normal pressure (1 atm). The upper limit thereof is preferably 250° C. or lower and more preferably 220° C. or lower.

It suffices that the inorganic solid electrolyte-containing composition according to the embodiment of the present invention contains at least one kind of dispersion medium, and it may contain two or more kinds thereof.

In the present invention, the content of the dispersion medium in the inorganic solid electrolyte-containing composition is not particularly limited and can be appropriately set. For example, in the inorganic solid electrolyte-containing composition, it is preferably 20% to 80% by mass, more preferably 30% to 70% by mass, and particularly preferably 40% to 60% by mass.

<Active Material>

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

(Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide, an organic substance, or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. The particle diameter (the volume average particle diameter) of the positive electrode active material is not particularly limited. For example, it can be set to 0.1 to 50 μm. The particle diameter of the positive electrode active material particle can be measured using the same method as that of the particle diameter of the inorganic solid electrolyte. In order to allow the positive electrode active material to have a predetermined particle diameter, an general pulverizer or classifier is used. For example, a mortar, a ball mill, a sand mill, a vibration ball mill, a satellite ball mill, a planetary ball mill, a swirling air flow jet mill, or a sieve is preferably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material may be used singly, or two or more thereof may be used in combination.

In a case of forming a positive electrode active material layer, the mass (mg) (mass per unit area) of the positive electrode active material per unit area (cm²) of the positive electrode active material layer is not particularly limited. It can be appropriately determined according to the designed battery capacity and can be set to, for example, 1 to 100 mg/cm².

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, in 100% by mass of the solid content,

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased. In the constitutional layer formed of the inorganic solid electrolyte-containing composition according to the embodiment of the present invention, it is possible to maintain a state where solid particles firmly bind to each other, and thus it is possible to use a negative electrode active material capable of forming an alloy with lithium, as the negative electrode active material. As a result, it is possible to increase the capacity of the all-solid state secondary battery and extend battery life.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably noncrystalline oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 20° to 40° in terms of 20 value in case of being measured by an X-ray diffraction method using CuKα rays, and the oxide may have a crystalline diffraction line. The highest intensity in a crystalline diffraction line observed in a range of 40° to 70° in terms of 20 value is preferably 100 times or less and more preferably 5 times or less with respect to the intensity of a diffraction line at the apex in a broad scattering band observed in a range of 20° to 40° in terms of 2θ value, and it is still more preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contains at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of the cycle characteristics. However, since the inorganic solid electrolyte-containing composition according to the embodiment of the present invention contains the above-described polymer binder formed of the component constituting a polymer binder, and thus it is possible to suppress the deterioration of the cycle characteristics. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, an Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. The volume average particle diameter of the negative electrode active material is not particularly limited; however, it is preferably 0.1 to 60 μm. The volume average particle diameter of the negative electrode active material particles can be measured using the same method as that of the particle diameter of the inorganic solid electrolyte. In order to obtain the predetermined particle diameter, a typical pulverizer or classifier is used as in the case of the positive electrode active material.

The negative electrode active material may be used singly, or two or more negative electrode active materials may be used in combination.

In a case of forming a negative electrode active material layer, the mass (mg) (mass per unit area) of the negative electrode active material per unit area (cm²) in the negative electrode active material layer is not particularly limited. It can be appropriately determined according to the designed battery capacity and can be set to, for example, 1 to 100 mg/cm².

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% by mass to 75% by mass, in 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

(Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃. In addition, the surface of the electrode containing the positive electrode active material or negative electrode active material may be subjected to a surface treatment with sulfur or phosphorous.

Further, the particle surface of the positive electrode active material or negative electrode active material may be subjected to a surface treatment with an actinic ray or an active gas (plasma or the like) before and after the surface coating.

<Conductive Auxiliary Agent>

The inorganic solid electrolyte-containing composition according to the embodiment of the present invention preferably contains a conductive auxiliary agent, and for example, it is preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

One kind of conductive auxiliary agent may be contained, or two or more kinds thereof may be contained.

The shape of the conductive auxiliary agent is not particularly limited but is preferably a particle shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in 100% by mass of the solid content.

<Lithium Salt>

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

<Dispersing Agent>

Since the above-described soluble polymer also functions as a dispersing agent, the inorganic solid electrolyte-containing composition according to the embodiment of the present invention does not have to contain a dispersing agent other than the soluble polymer. In a case where the inorganic solid electrolyte-containing composition contains a dispersing agent other than the soluble polymer, a dispersing agent that is generally used for an all-solid state secondary battery can be appropriately selected and used as the dispersing agent. Generally, a compound intended for particle adsorption and steric repulsion and/or electrostatic repulsion is suitably used.

<Other Additives>

As components other than the respective components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the polymer that forms the above-described polymer binder, a typically used binder, or the like may be contained.

(Preparation of Inorganic Solid Electrolyte-Containing Composition)

The inorganic solid electrolyte-containing composition according to the embodiment of the present invention can be prepared by mixing an inorganic solid electrolyte, a polymer binder, a dispersion medium, preferably a conductive auxiliary agent, and further appropriately a lithium salt, and any other optionally constitutional components, as a mixture and preferably as a slurry by using, for example, various mixers that are used generally. In a case of an electrode composition, an active material is further mixed.

The mixing method is not particularly limited, and the components may be mixed at once or sequentially. A mixing environment is not particularly limited; however, examples thereof include a dry air environment and an inert gas environment. The mixing conditions are not particularly limited; however, they are preferably conditions under which a component constituting a polymer binder does not undergo a chemical reaction. They are appropriately set depending on the kind or combination of the functional groups or partial structure (I) and (II), the content of each component, and the like. For example, in a case where the soluble polymer has a blocked isocyanate group as the functional group or partial structure (I), the temperature is set to a temperature lower than the temperature at which an isocyanate group is regenerated (the temperature at which a blocking agent is deprotected).

[Sheet for an all-Solid State Secondary Battery]

A sheet for an all-solid state secondary battery according to the aspect of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery), and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

It suffices that the solid electrolyte sheet for an all-solid state secondary battery according to the embodiment of the present invention is a sheet having a solid electrolyte layer, and it may be a sheet in which a solid electrolyte layer is formed on a substrate or may be a sheet that is formed of a solid electrolyte layer without including a substrate. The solid electrolyte sheet for an all-solid state secondary battery may include another layer in addition to the solid electrolyte layer. Examples of the other layer include a protective layer (a stripping sheet), a collector, and a coating layer.

Examples of the solid electrolyte sheet for an all-solid state secondary battery according to the embodiment of the present invention include a sheet including a layer formed of the inorganic solid electrolyte-containing composition according to the embodiment of the present invention, a typical solid electrolyte layer, and a protective layer on a substrate in this order. The layer thickness of each layer that constitutes the solid electrolyte sheet for an all-solid state secondary battery is the same as the layer thickness of each layer described later in the all-solid state secondary battery.

The solid electrolyte layer included in the solid electrolyte sheet for an all-solid state secondary battery is preferably formed of the inorganic solid electrolyte-containing composition according to the embodiment of the present invention.

In the process of forming a film of the inorganic solid electrolyte-containing composition according to the embodiment of the present invention, the soluble polymers C1-I and C1-II in a dissolved state undergo a chemical reaction or the soluble polymer C2 undergoes a chemical reaction, as the component constituting a polymer binder. The chemical reaction caused by the soluble polymer is determined depending on the functional group or the partial structure, which is as described above. As this chemical reaction progresses, the solubility of the soluble polymer in a dispersion medium gradually decreases, and thus the soluble polymer is solidified or precipitated preferably in a particle shape while maintaining the adsorption state with solid particles. As a result, it is possible to sufficiently construct ion conduction paths without coating the entire surface of the solid particles while maintaining a strong binding between the solid particles. The solid electrolyte layer composed of this inorganic solid electrolyte-containing composition preferably contains, as particles, a polymer binder that is formed by the chemical reaction of the soluble polymer constituting a polymer binder.

The constitutional layer formed of the inorganic solid electrolyte-containing composition according to the embodiment of the present invention contains, as described above, a polymer binder formed by the chemical reaction of the soluble polymers C1-I and C1-II or the soluble polymer C2. However, the entire soluble polymer contained in the inorganic solid electrolyte-containing composition needs not to form a polymer binder, and a soluble polymer that has not undergone a chemical reaction may be contained (remained) as long as the action and effect of the present invention are not impaired. The content of each component in the constitutional layer is not particularly limited; however, the contents are preferably the same as the contents of the respective components with respect to the solid content of the inorganic solid electrolyte-containing composition according to the embodiment of the present invention. However, the content of the polymer binder is generally equal to the total content of the soluble polymer.

The substrate is not particularly limited as long as it can support the solid electrolyte layer, and examples thereof include a sheet body (plate-shaped body) formed of materials described below regarding the collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

It suffices that an electrode sheet for an all-solid state secondary battery according to the embodiment of the present invention (simply also referred to as an “electrode sheet”) is an electrode sheet including an active material layer, and it may be a sheet in which an active material layer is formed on a substrate (collector) or may be a sheet that is formed of an active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order.

At least one of the solid electrolyte layer or the active material layer, which is included in the electrode sheet, is formed of the inorganic solid electrolyte-containing composition according to the embodiment of the present invention. In the solid electrolyte layer and the active material layer, which are formed of the inorganic solid electrolyte-containing composition according to the embodiment of the present invention, the polymer binder that is formed of the soluble polymer is the same as the polymer binder of the solid electrolyte layer included in the above-described solid electrolyte sheet for an all-solid state secondary battery. In addition, the contents of the respective components in this solid electrolyte layer or active material layer are not particularly limited; however, the contents are preferably the same as the contents of the respective components with respect to the solid content of the inorganic solid electrolyte-containing composition (the electrode composition) according to the embodiment of the present invention. However, the content of the polymer binder is generally equal to the total content of the soluble polymer. The thickness of each of the layers forming the electrode sheet according to the embodiment of the present invention is the same as the layer thickness of each of the layers described below regarding the all-solid state secondary battery. The electrode sheet according to the embodiment of the present invention may include the above-described other layers.

It is noted that in a case where the solid electrolyte layer or the active material layer is not formed of the inorganic solid electrolyte-containing composition according to the embodiment of the present invention, it is formed of a general constitutional layer forming material.

In the sheet for an all-solid state secondary battery according to the embodiment of the present invention, at least one layer of the solid electrolyte layer or the active material layer is formed of the inorganic solid electrolyte-containing composition according to the embodiment of the present invention, and a flat constitutional layer having a flat surface, where solid particles are firmly bound to each other, while suppressing the increase in interface resistance between solid particles is included. As a result, in a case where the sheet for an all-solid state secondary battery according to the embodiment of the present invention is used as a constitutional layer of the all-solid state secondary battery, it is possible to realize the lower resistance (the high conductivity) of the all-solid state secondary battery and excellent cycle characteristics. In particular, in the electrode sheet for an all-solid state secondary battery and the all-solid state secondary battery, in which the active material layer is formed of the inorganic solid electrolyte-containing composition according to the embodiment of the present invention, the active material layer and the collector exhibit strong adhesiveness, and thus it is possible to realize further improvement of the cycle characteristics. As a result, the sheet for an all-solid state secondary battery according to the embodiment of the present invention is suitably used as a sheet with which a constitutional layer of an all-solid state secondary battery can be formed.

In the present invention, each layer constituting a sheet for an all-solid state secondary battery may have a monolayer structure or a multilayer structure.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a substrate or a collector (another layer may be interposed) to form a layer (a coated and dried layer) consisting of an inorganic solid electrolyte-containing composition. As a result, the sheet for an all-solid state secondary battery including the substrate or the collector, and the coated and dried layer can be produced. In particular, in a case where a film of the inorganic solid electrolyte-containing composition according to the embodiment of the present invention is formed on a collector to produce a sheet for an all-solid state secondary battery, it is possible to strengthen the adhesion between the collector and the active material layer. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effect of the present invention is not impaired, and the residual amount thereof, for example, in each of the layers may be 3% by mass or lower. As described above, this coated and dried layer contains a polymer binder formed by the chemical reaction of the soluble polymer.

In the manufacturing method for a sheet for an all-solid state secondary battery according to the embodiment of the present invention, each of the steps such as coating and drying will be described in the following manufacturing method for an all-solid state secondary battery.

In the above-described preferred method, in a case where a film of the inorganic solid electrolyte-containing composition according to the embodiment of the present invention is formed on a collector to produce a sheet for an all-solid state secondary battery, it is possible to strengthen the adhesion between the collector and the active material layer.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the substrate, the protective layer (particularly stripping sheet), or the like can also be stripped.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is preferably formed on a positive electrode collector to configure a positive electrode. The negative electrode active material layer is preferably formed on a negative electrode collector to configure a negative electrode.

At least one layer of the negative electrode active material layer, the positive electrode active material layer, or the solid electrolyte layer is formed of the inorganic solid electrolyte-containing composition according to the embodiment of the present invention, and at least one of the solid electrolyte layer, the negative electrode active material layer, or the positive electrode active material layer is preferably formed of the inorganic solid electrolyte-containing composition according to the embodiment of the present invention. An aspect in which all of the layers are formed of the inorganic solid electrolyte-containing composition according to the aspect of the present invention is also one of the preferred aspects. In the present invention, forming the constitutional layer of the all-solid state secondary battery by using the inorganic solid electrolyte-containing composition according to the embodiment of the present invention includes an aspect in which the constitutional layer is formed by using the sheet for an all-solid state secondary battery according to the embodiment of the present invention (however, in a case where a layer other than the layer formed of the inorganic solid electrolyte-containing composition according to the embodiment of the present invention is provided, a sheet from which this layer is removed). In the active material layer or the solid electrolyte layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention (however, the content of the polymer binder is generally equal to the total content of the soluble polymer). In a case where the active material layer or the solid electrolyte layer is not formed of the inorganic solid electrolyte-containing composition according to the embodiment of the present invention, a known material in the related art can be used.

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

Each of the positive electrode active material layer and the negative electrode active material layer may include a collector on the side opposite to the solid electrolyte layer.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

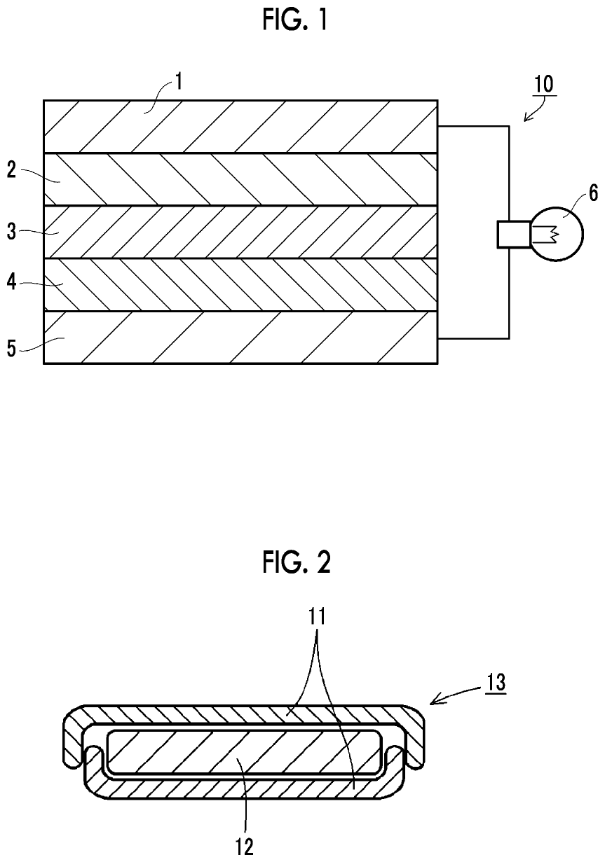

Hereinafter, the all-solid state secondary battery of the preferred embodiments of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In the case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode side return to the positive electrode, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is put into a 2032-type coin case (for example, see FIG. 2), the all-solid state secondary battery will be referred to as the “laminate 12 for an all-solid state secondary battery”, and a battery (coin type) prepared by putting this laminate 12 for an all-solid state secondary battery into a 2032-type coin case 11 will be referred to as an “all-solid state secondary battery 13”, thereby referring to both batteries distinctively in some cases.

(Positive Electrode Active Material Layer, Solid Electrolyte Layer, and Negative Electrode Active Material Layer)

In the all-solid state secondary battery 10, all of the positive electrode active material layer, the solid electrolyte layer, and the negative electrode active material layer are formed of the inorganic solid electrolyte-containing composition of the embodiment of the present invention. In the positive electrode active material layer 4, the solid electrolyte layer 3, and the negative electrode active material layer 2, the polymer binder that is formed of the soluble polymer is the same as the polymer binder of the solid electrolyte layer included in the above-described solid electrolyte sheet for an all-solid state secondary battery. This all-solid state secondary battery 10 exhibits excellent battery performance. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

In the present invention, in a case where the constitutional layer is formed of the inorganic solid electrolyte-containing composition according to the embodiment of the present invention, it is possible to realize an all-solid state secondary battery having low resistance and excellent cycle characteristics.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above thickness of the above negative electrode active material layer.

The positive electrode collector 5 and the negative electrode collector 1 are preferably an electron conductor.

In the present invention, either or both of the positive electrode collector and the negative electrode collector will also be simply referred to as the collector. As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

In a case where the all-solid state secondary battery 10 has a constitutional layer other than the constitutional layer formed of the inorganic solid electrolyte-containing composition according to the embodiment of the present invention, a layer formed of a known constitutional layer forming material can also be applied.

In the present invention, a functional layer, a functional member, or the like may be appropriately interposed or disposed between each layer of the negative electrode collector, the negative electrode active material layer, the solid electrolyte layer, the positive electrode active material layer, and the positive electrode collector on the outside thereof. In addition, each layer may be constituted of a single layer or multiple layers.

[Manufacture of all-Solid State Secondary Battery]

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) which includes (is carried out through) a step of coating an appropriate substrate (for example, a metal foil which serves as a collector) with the inorganic solid electrolyte-containing composition according to the embodiment of the present invention and forming a coating film (forming a film).

For example, an inorganic solid electrolyte-containing composition containing a positive electrode active material is applied as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Furthermore, an inorganic solid electrolyte-containing composition containing a negative electrode active material is applied as a material for a negative electrode (a negative electrode composition) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector and overlaying a positive electrode collector thereon.

As another method, the following method can be exemplified. That is, the positive electrode sheet for an all-solid state secondary battery is produced as described above. In addition, an inorganic solid electrolyte-containing composition containing a negative electrode active material is applied as a material for a negative electrode (a negative electrode composition) onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a substrate, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the substrate. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this manner, the solid electrolyte layer is transferred to the positive electrode sheet for an all-solid state secondary battery or the negative electrode sheet for an all-solid state secondary battery. Then, the solid electrolyte layer from which the substrate of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this manner, an all-solid state secondary battery can be manufactured. The pressurizing method and the pressurizing conditions in this method are not particularly limited, and a method and pressurizing conditions described in the pressurization of the applied composition, which will be described later, can be applied.

The solid electrolyte layer or the like can also be formed on the substrate or the active material layer, for example, by pressure-molding the inorganic solid electrolyte-containing composition or the like under a pressurizing condition described below, or the solid electrolyte or a sheet molded body of the active material.

In the above production method, it suffices that the inorganic solid electrolyte-containing composition according to the embodiment of the present invention is used in any one of the positive electrode composition, the inorganic solid electrolyte-containing composition, or the negative electrode composition. The inorganic solid electrolyte-containing composition according to the embodiment of the present invention is preferably used in the inorganic solid electrolyte-containing composition, and the inorganic solid electrolyte-containing composition according to the embodiment of the present invention can be used in any of the compositions.

In a case where the solid electrolyte layer or the active material layer is formed of a composition other than the inorganic solid electrolyte-containing composition according to the embodiment of the present invention, examples thereof include a typically used composition. In addition, the negative electrode active material layer can also be formed by binding ions of a metal belonging to Group 1 or Group 2 in the periodic table, which are accumulated on a negative electrode collector during initialization described below or during charging for use, without forming the negative electrode active material layer during the manufacturing of the all-solid state secondary battery to electrons and precipitating the ions on a negative electrode collector the like as a metal.

<Formation (Film Formation) of Each Layer>

The formation (coating and drying) of a film of the inorganic solid electrolyte-containing composition according to the embodiment of the present invention is carried out while the soluble polymer, which is a component constituting a polymer binder, undergoes a chemical reaction and is gradually solidified and precipitated. The method of carrying out a chemical reaction is not particularly limited, and examples thereof include a method in which drying conditions are selected in the film forming step.

The method of applying the inorganic solid electrolyte-containing composition or the like is not particularly limited and can be appropriately selected. Examples thereof include coating (preferably wet-type coating), spray coating, spin coating, dip coating, slit coating, stripe coating, and bar coating. The coating conditions are appropriately determined; however, it is preferable that the above-described component constituting a polymer binder does not undergo a chemical reaction, and for example, the temperature conditions are preferably a temperature lower than the following drying temperature.

The applied inorganic solid electrolyte-containing composition is subjected to a drying treatment (a heating treatment). In the drying treatment, the soluble polymer in the dissolved state in the applied inorganic solid electrolyte-containing composition undergoes a chemical reaction, while maintaining the adsorption to the solid particles, and is solidified or precipitated, for example, in a particle shape, whereby the solid particles can be bound to each other while suppressing an increase in interface resistance. Coupled with the excellent dispersion characteristics of the inorganic solid electrolyte-containing composition, the solidification or precipitation of such a soluble polymer makes it possible to bind solid particles while suppressing the variation in contact state and the increase in interface resistance, and furthermore makes it possible to form a coated and dried layer having a flat surface.

In the drying treatment, in a case where the inorganic solid electrolyte-containing composition according to the embodiment of the present invention is heated, it is conceived that the chemical reaction between a functional group or partial structure (I) and a functional group or partial structure (II) of the soluble polymer is accelerated in association with temperature rise, and at the same time, volatilization of the dispersion medium is also promoted, the molecular weight of the soluble polymer in the dissolved state increases, and the solubility in the dispersion medium gradually decreases. In this way, the soluble polymer in the dissolved state is solidified or precipitated as a polymer binder.

The drying treatment may be carried out each time after the inorganic solid electrolyte-containing composition is applied or may be carried out after it is subjected to multilayer application.

The drying conditions are not particularly limited as long as the above-described chemical reaction proceeds. For example, the drying temperature is appropriately set in consideration of the above-described reaction conditions under which the chemical reaction proceeds, depending on the kind of the functional group or partial structure (I) and the functional group or partial structure (II), and the like. For example, it is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case of carrying out heating in such a temperature range, it is possible to remove the dispersion medium while the soluble polymer undergoes a chemical reaction to form a coated and dried layer. This temperature range is preferable since the temperature is not excessively increased and each member of the all-solid state secondary battery is not impaired. As a result, excellent overall performance is exhibited in the all-solid state secondary battery, and it is possible to obtain a good binding property and a good ion conductivity even without pressurization.

In a case where the inorganic solid electrolyte-containing composition according to the embodiment of the present invention is applied and dried as described above, it is possible to suppress the variation in the contact state and bind solid particles, and furthermore, it is possible to form a coated and dried layer (an inorganic solid electrolyte layer) having a flat surface.

After applying the inorganic solid electrolyte-containing composition, it is preferable to pressurize each layer or the all-solid state secondary battery after superimposing the constitutional layers or producing the all-solid state secondary battery. Examples of the pressurizing methods include a method using a hydraulic cylinder press machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. It is also possible to carry out press at a temperature higher than the glass transition temperature of the polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate substrates and then laminated by carrying out transfer.

The atmosphere during the manufacturing process, for example, during coating, heating, or pressurization, is not particularly limited and may be any atmosphere such as an atmosphere of atmospheric air, an atmosphere of dried air (the dew point: −20° C. or lower), or an atmosphere of an inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Usages of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

1. Synthesis of Polymer and Preparation of Polymer Solution

Polymers shown in the following chemical formulae were synthesized as follows to prepare polymer solutions.

First, each of polymers B-1 to B-6, B-10, B-14, and B-15 was synthesized as the soluble polymer C1-I or C1-II having a functional group or partial structure (I) or (II).

### Synthesis Example 1: Synthesis of Polymer B-1 and Preparation of Polymer Solution B-1

To a 100 mL graduated cylinder, 28.8 g of dodecyl acrylate (manufactured by Tokyo Chemical Industry Co., Ltd.), 7.2 g of hydroxyethyl acrylate (manufactured by FUJIFILM Wako Pure Chemical Corporation), and 0.1 g of a polymerization initiator V-601 (product name, manufactured by FUJIFILM Wako Pure Chemical Corporation) were added and dissolved in 36 g of butyl butyrate to prepare a monomer solution. To a 300 mL three-necked flask, 18 g of butyl butyrate was added and stirred at 80° C., and then the above monomer solution was added dropwise thereto over 2 hours. After the completion of the dropwise addition, the solution was heated to 90° C. and stirred for 2 hours. Then, the reaction solution was added dropwise to methanol to obtain a polymer B-1 as a precipitate. After drying under reduced pressure at 60° C. for 5 hours, the precipitate was redissolved in any solvent. In this way, a polymer B-1 (mass average molecular weight: 50,000) was synthesized to obtain a binder solution B-1 (concentration: 10% by mass) consisting of the polymer B-1.

### Synthesis Examples 2 to 7: Synthesis of Polymers B-3 to B-6 and B-10 and Preparation of Polymer Solutions B-2 to B-6 and B-10

Each of polymers B-3 to B-6 and B-10 (an acrylic polymer or a vinyl polymer) was synthesized in the same manner as in Synthesis Example 1, and each of polymer solutions B-3 to B-6 and B-10 (concentration: 10% by mass) consisting of each polymer was obtained except that in Synthesis Example 1, a compound from which each constitutional component is derived was adjusted so that the polymers B-3 to B-6 and B-10 had the composition (the kind and the content of the constitutional component) shown in the following chemical formula. Further, a polymer solution B-2 (concentration: 10% by mass) was prepared by using a polymer B-2 (an aminoethylated acrylic polymer NK-350 having a polyethyleneimine chain (product name, manufactured by Nippon Shokubai Co., Ltd.).

### Synthesis Example 8: Synthesis of Polymer B-14 and Preparation of Polymer Solution B-14

200 parts by mass of ion exchange water, 130 parts by mass of vinylidene fluoride, 50 parts by mass of hexafluoropropylene, and 20 parts by mass of hydroxyethyl acrylate were added to the autoclave, 2 parts by mass of diisopropyl peroxydicarbonate was added, and the mixture was stirred at 30° C. for 24 hours. After completion of the polymerization, the precipitate was filtered and dried at 100° C. for 10 hours to obtain a polymer (binder) B-14. The mass average molecular weight of the obtained binder was 60,000. In this way, a polymer B-14 (a fluorine polymer) was synthesized to obtain a polymer solution B-14 (concentration: 10% by mass) consisting of the polymer B-14.

### Synthesis Example 9: Synthesis of Polymer B-15 and Preparation of Polymer Solution B-15

150 parts by mass of toluene, 25 parts by mass of styrene, and 75 parts by mass of 1,3-butadiene were added to an autoclave, and 1 part by mass of a polymerization initiator V-601 (manufactured by FUJIFILM Wako Pure Chemical Corporation) were added thereto. Then, the temperature was raised to 80° C., and stirring was carried out for 3 hours. Then, the temperature was raised to 90° C., and the reaction was carried out until the conversion rate reached 100%. The obtained solution was reprecipitated in methanol and dried to obtain a solid, and 3 parts by mass of 2,6-di-t-butyl-p-cresol and 3 parts by mass of maleic acid anhydride were added with respect to 100 parts by mass of the polymer obtained solid, and then the reaction was carried out at 180° C. for 5 hours. The obtained solution was reprecipitated in acetonitrile, and the obtained solid was dried to obtain a polymer. The mass average molecular weight of this polymer was 90,000. Then, 50 parts by mass of the polymer obtained above was dissolved in 50 parts by mass of cyclohexane and 150 parts by mass of tetrahydrofuran (THF), and then the solution was brought to 70° C. 3 parts by mass of n-butyl lithium, 3 parts by mass of 2,6-di-t-butyl-p-cresol, 1 part by mass of bis(cyclopentadienyltitanium dichloride), and 2 parts by mass of diethyl aluminum chloride were added thereto, and the resultant mixture was subjected to the reaction at a hydrogen pressure of 10 kg/cm² for 1 hour, distilled off, and dried to obtain a polymer B-15. The mass average molecular weight of the polymer B-15 was 92,000.

In this way, a polymer B-15 (a hydrocarbon polymer) was synthesized to obtain a polymer solution B-15 (concentration: 10% by mass) consisting of the polymer B-15.

Then, each of polymers B-7 to B-9 and B-11 to B-13 was synthesized as the soluble polymer C2 having functional groups or partial structures (I) and (II).

### Synthesis Examples 10 to 15: Synthesis of Polymers B-7 to B-9 and B-11 to B-13, and Preparation of Polymer Solutions B-7 to B-9 and B-11 to B-13

Each of polymers B-7 to B-9 and B-11 to B-13 (an acrylic polymer or a vinyl polymer) was synthesized in the same manner as in Synthesis Example 1, and each of polymer solutions B-7 to B-9 and B-11 to B-13 (concentration: 10% by mass) consisting of each polymer was obtained except that in Synthesis Example 1, a compound from which each constitutional component is derived was adjusted so that the polymers B-7 to B-9 and B-11 to B-13 had the composition (the kind and the content of the constitutional component) shown in the following chemical formula.

Next, a comparative soluble polymer BA-1 was synthesized.

### Synthesis Example 16: Synthesis of Polymer BA-1 and Preparation of Polymer Solution BA-1

A polymer BA-1 (an acrylic polymer) was synthesized in the same manner as in Synthesis Example 1, and a polymer solution BA-1 (concentration: 10% by mass) consisting of the polymer BA-1 was obtained except that in Synthesis Example 1, a compound from which each constitutional component is derived was used so that the polymer BA-1 had the composition (the kind and the content of the constitutional component) shown in the following chemical formula.

### Synthesis Example 17: Synthesis of Polymer BA-2 and Preparation of Polymer Dispersion Liquid BA-2

To a 100 mL volumetric flask, 11.7 g of hydroxyethyl acrylate (manufactured by FUJIFILM Wako Pure Chemical Corporation) and 0.17 g of a polymerization initiator V-601 (product name, manufactured by FUJIFILM Wako Pure Chemical Corporation) were added and dissolved in 13.6 g of butyl butyrate to prepare a monomer solution. To a 200 mL three-necked flask, 10.2 g of a macromonomer solution was added, dissolved in 16.9 g of butyl butyrate, and stirred at 80° C., and then the above monomer solution was added dropwise thereto over 2 hours. After completion of the dropwise addition, the mixture was stirred at 80° C. for 2 hours, and then heated to 90° C. and stirred for 2 hours to synthesize a dispersion liquid BA-2 of a (meth)acrylic polymer, which subsequently was diluted with butyl butyrate to prepare the dispersion liquid BA-2 having a concentration of 10%. The mass average molecular weight of the polymer BA-2 obtained in this way was 150,000. The average particle diameter of the binder in the polymer dispersion liquid BA-2 was 80 nm.

In this way, a polymer BA-2 (a particle-shaped polymer) was synthesized to obtain a polymer dispersion liquid BA-2 (concentration: 10% by mass) consisting of the polymer BA-2.

(Synthesis of Macromonomer)

To a 1 L graduated cylinder, 130.2 g of ethyl methacrylate (manufactured by Tokyo Chemical Industry Co., Ltd.), 330.7 g of dodecyl methacrylate (manufactured by Tokyo Chemical Industry Co., Ltd.), 4.5 g of 3-mercaptopropionic acid, and 4.61 g of a polymerization initiator V-601 (manufactured by FUJIFILM Wako Pure Chemical Corporation) were added and stirred to be dissolved, whereby a monomer solution was prepared. To a 2 L three-necked flask, 465.5 g of toluene (manufactured by FUJIFILM Wako Pure Chemical Corporation) was added and stirred at 80° C., and then the above monomer solution was added dropwise thereto over 2 hours. After completion of the dropwise addition, stirring was carried out at 80° C. for 2 hours, and then the temperature was raised to 90° C., and stirring was carried out for 2 hours. 275 mg of 2,2,6,6-tetramethylpiperidine 1-oxyl (manufactured by FUJIFILM Wako Pure Chemical Corporation), 27.5 g of glycidyl methacrylate (manufactured by Tokyo Chemical Industry Co., Ltd.), and 5.5 g of tetrabutylammonium bromide (manufactured by FUJIFILM Wako Pure Chemical Corporation) were added thereto, and the mixture was stirred at 120° C. for 3 hours. After allowing the solution to stand at room temperature, it was poured into 1,800 g of methanol to remove the supernatant. Butyl butyrate was added thereto, and methanol was distilled off under reduced pressure to obtain a butyl butyrate solution of a macromonomer. The solid content concentration thereof was 48.9% by mass. The mass average molecular weight of the macromonomer obtained in this way was 10,000.

### Synthesis Example 18: Synthesis of Polymer BA-3 and Preparation of Polymer Dispersion Liquid BA-3

To a 100 mL volumetric flask, 8.4 g of methyl methacrylate (manufactured by FUJIFILM Wako Pure Chemical Corporation), 3.3 g of 2-[(3,5-dimethylpyrazolyl)carbonylamino]ethyl methacrylate (manufactured by FUJIFILM Wako Pure Chemical Corporation), and 0.17 g of a polymerization initiator V-601 (product name, manufactured by FUJIFILM Wako Pure Chemical Corporation) were added and dissolved in 13.6 g of butyl butyrate to prepare a monomer solution. To a 200 mL three-necked flask, 10.2 g of a macromonomer solution was added, dissolved in 16.9 g of butyl butyrate, and stirred at 80° C., and then the above monomer solution was added dropwise thereto over 2 hours. After completion of the dropwise addition, the mixture was stirred at 80° C. for 2 hours, and then heated to 90° C. and stirred for 2 hours to synthesize a dispersion liquid BA-3 of a (meth)acrylic polymer, which subsequently was diluted with butyl butyrate to prepare the dispersion liquid BA-3 having a concentration of 10%. The mass average molecular weight of the polymer BA-3 obtained in this way was 200,000. The average particle diameter of the binder in the polymer dispersion liquid BA-2 was 70 nm.

### Synthesis Example 19: Synthesis of Polymer BA-4 and Preparation of Polymer Solution BA-4

To a 100 mL graduated cylinder, 32.4 g of dodecyl acrylate (manufactured by Tokyo Chemical Industry Co., Ltd.), 3.6 g of acrylic acid (manufactured by FUJIFILM Wako Pure Chemical Corporation), and 0.1 g of a polymerization initiator V-601 (product name, manufactured by FUJIFILM Wako Pure Chemical Corporation) were added and dissolved in 36 g of butyl butyrate to prepare a monomer solution. To a 300 mL three-necked flask, 18 g of butyl butyrate was added and stirred at 80° C., and then the above monomer solution was added dropwise thereto over 2 hours. After the completion of the dropwise addition, the solution was heated to 90° C. and stirred for 2 hours. Then, the reaction solution was added dropwise to methanol to obtain a polymer BA-4 as a precipitate. After drying under reduced pressure at 60° C. for 5 hours, the precipitate was redissolved in any solvent. In this way, a polymer BA-4 (mass average molecular weight: 50,000) was synthesized to obtain a binder solution BA-4 (concentration: 10% by mass) consisting of the polymer BA-4.

Each of the polymers synthesized is shown below. The number at the bottom right of each constitutional component indicates the content (% by mass). Table 1 shows the mass average molecular weight of each polymer according to the above measurement method.

It is noted that all the synthesized polymers were dissolved in the dispersion medium in the composition described later.

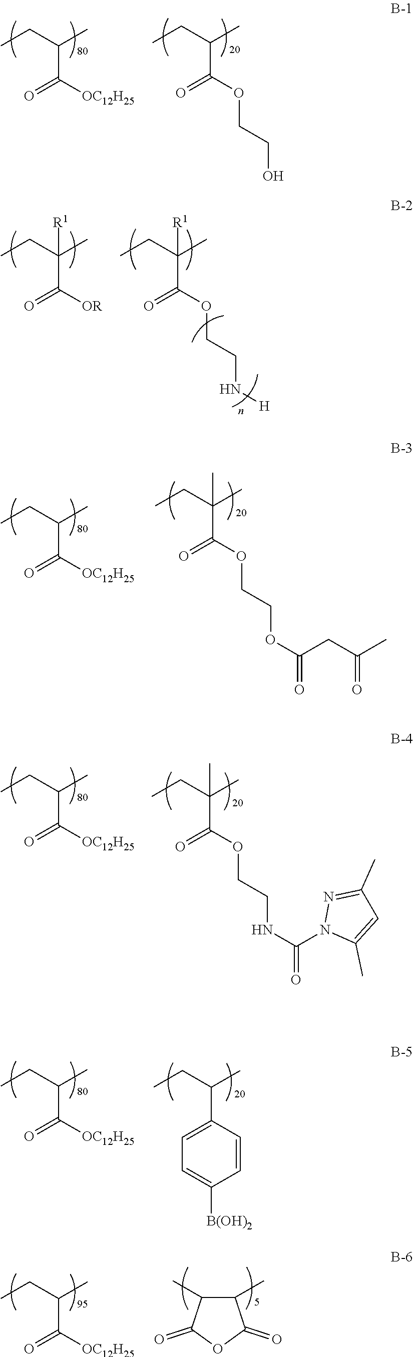

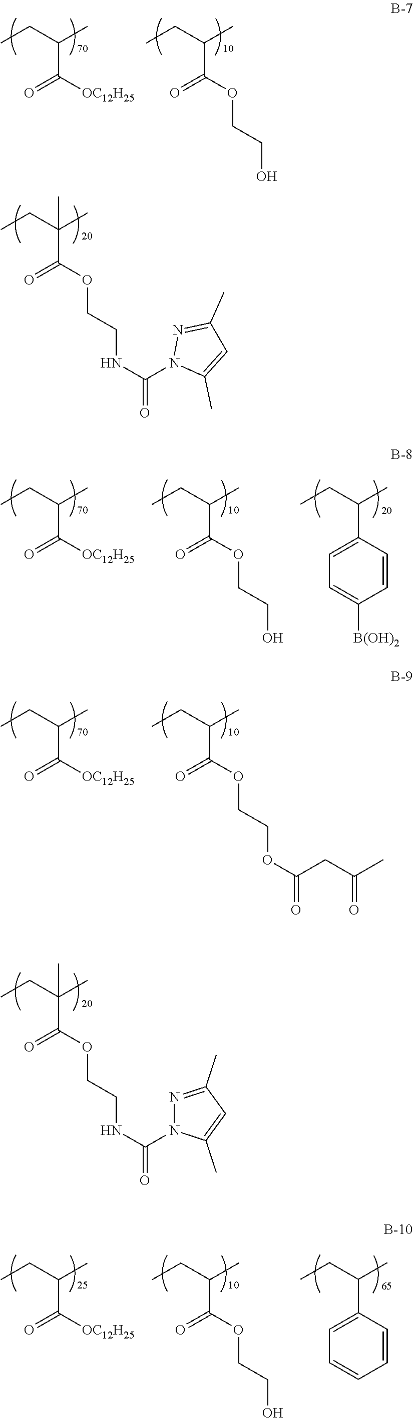

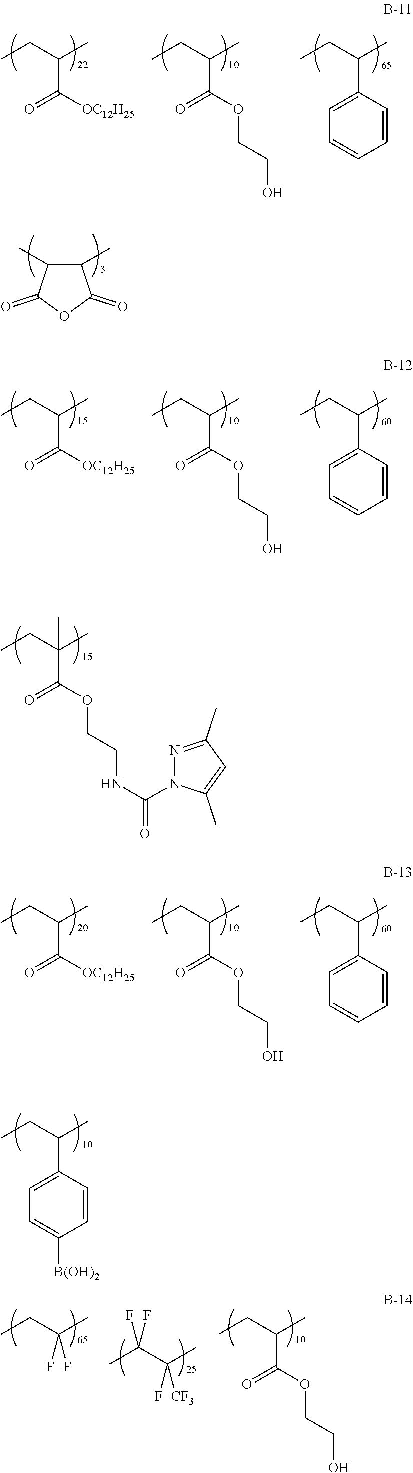

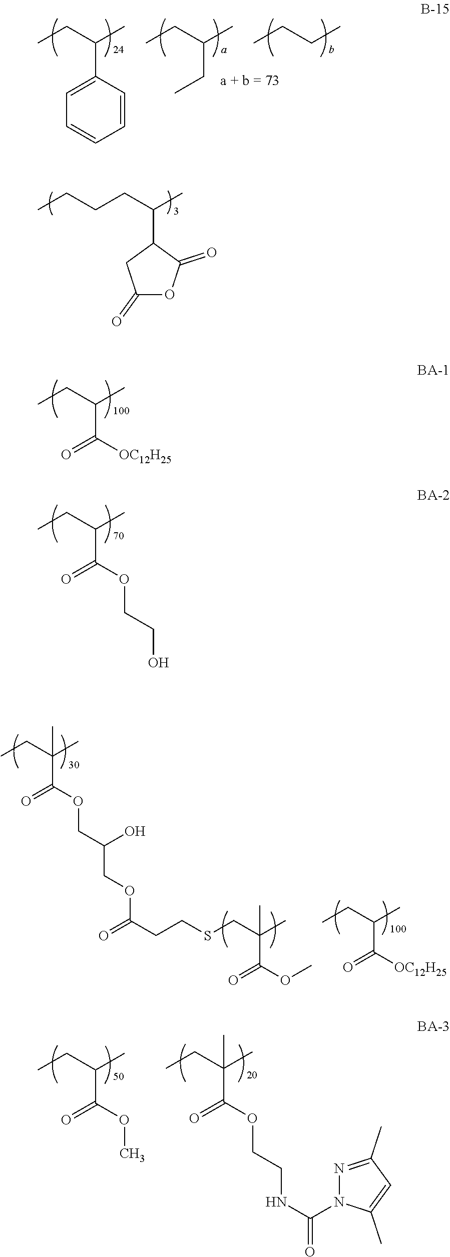

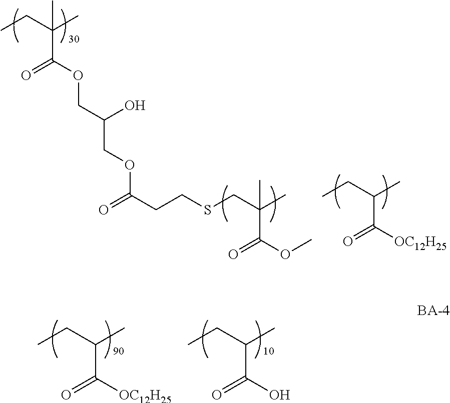

2. Preparation of Binder Constitutional Component-Containing Composition (Hereinafter Referred to as Binder Solution)

The polymer solution of the soluble polymer C1-I and the polymer solution of the soluble polymer C1-II, synthesized as described above were mixed in the combination shown in Table 1 at a ratio of a mass ratio of 1:1 (solid content amount) of soluble polymers to prepare binder solutions S-1 to S-6, S-10 to S-12, and S-16 to S-18. Further, a comparative binder dispersion liquid T-6 and comparative binder solutions T-7 and T-8 were mixed and prepared in the combinations shown in Table 1.

As binder solutions S-7 to S-9 and S-13 to S-15, containing the soluble polymer C2, as well as comparative binder solutions T-1 to T-5, the respective polymer solutions shown in Table 1 prepared as described above were used as they were.

It is noted that in the column of “Functional group or partial structure” of Table 1 below, (I) and (II) described at the beginning of the functional group or partial structure indicate that they are a functional group or partial structure selected from the group (I) and the group (II), respectively. In addition, in a case of the soluble polymer C2, the functional group or partial structure selected from both groups is described together using “/”.

Further, the soluble polymer C1-II contained in the binder solutions T-3 to T-5 is described in the column of “Soluble polymer C1-I or C2”. The ethylene glycol of the binder solutions T-7 and T-8 and the polymer BA-4 are described in the column of “Soluble polymer C1-I or C2” or in the column of “Soluble polymer C1-II”, respectively.

In Table 1, “-” in each column means that the corresponding component is not contained.

TABLE 1

| | Soluble polymer C1-I or C2 | | | Soluble polymer C1-II | | | |
|---|---|---|---|---|---|---|---|
| Binder | Polymer | | Mass average | Polymer | | Mass average | |
| solution | solution | Functional group | molecular | solution | Functional group | molecular | |
| No. | No. | or partial structure | weight | No. | or partial structure | weight | (I):(II) |
| S-1 | B-1 | (I) Hydroxyl group | 50000 | B-4 | (II) Blocked isocyanate | 60000 | 1:1 |
| S-2 | B-1 | (I) Hydroxyl group | 50000 | B-5 | (II) Boric acid | 42000 | 1:1 |
| S-3 | B-1 | (I) Hydroxyl group | 50000 | B-6 | (II) Acid anhydride | 45000 | 1:0.25 |
| S-4 | B-2 | (I) Amino group | 100000 | B-6 | (II) Acid anhydride | 45000 | 1:0.25 |
| S-5 | B-2 | (I) Amino group | 100000 | B-4 | (II) Blocked isocyanate | 60000 | 1:1 |
| S-6 | B-3 | (I) 1,3-dicarbonyl | 45000 | B-4 | (II) Blocked isocyanate | 60000 | 1:1 |
| S-7 | B-7 | (I) Hydroxyl group/(II) blocked isocyanate | 65000 | — | — | — | — |
| S-8 | B-8 | (I) Hydroxyl group/(II) boric acid | 60000 | — | — | — | — |
| S-9 | B-9 | (I) 1,3-dicarbonyl | 55000 | — | — | — | — |
| S-10 | B-10 | (I) Hydroxyl group | 50000 | B-4 | (II) Blocked isocyanate | 60000 | 1:2 |
| S-11 | B-10 | (I) Hydroxyl group | 50000 | B-5 | (II) Boric acid | 42000 | 1:2 |
| S-12 | B-10 | (I) Hydroxyl group | 50000 | B-6 | (II) Acid anhydride | 45000 | 1:0.5 |
| S-13 | B-11 | (I) Hydroxyl group/(II) acid anhydride | 60000 | — | — | — | — |
| S-14 | B-12 | (I) Hydroxyl group/(II) blocked isocyanate | 75000 | — | — | — | — |
| S-15 | B-13 | (I) Hydroxyl group/(II) boric acid | 52000 | — | — | — | — |
| S-16 | B-14 | (I) Hydroxyl group | 60000 | B-15 | (II) Acid anhydride | 92000 | 1:0.3 |
| S-17 | B-14 | (I) Hydroxyl group | 60000 | B-6 | (II) Acid anhydride | 45000 | 1:0.5 |
| S-18 | B-1 | (I) Hydroxyl group | 50000 | B-15 | (II) Acid anhydride | 92000 | 1:0.15 |
| T-1 | BA-1 | — | 48000 | — | — | — | — |
| T-2 | B-1 | (I) Hydroxyl group | 50000 | — | — | — | — |
| T-3 | B-4 | (II) Blocked isocyanate | 60000 | — | — | — | — |
| T-4 | B-5 | (II) Boric acid | 42000 | — | — | — | — |
| T-5 | B-6 | (II) Acid anhydride | 45000 | — | — | — | — |
| T-6 | BA-2 | (I) Hydroxyl group | 150000 | BA-3 | (II) Blocked isocyanate | 200000 | 1:1 |
| T-7 | — | Ethylene glycol | — | B-4 | (II) Blocked isocyanate | 60000 | 1:1 |
| T-8 | B-1 | (I) Hydroxyl group | 50000 | BA-4 | Carboxy group | 50000 | 1:1 |

3. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass, hereinafter, may be referred to as LPS). The particle diameter of the Li—P—S-based glass was 15 μm.

### Example 1

Each of the compositions shown in Tables 2-1 to 2-3 (collectively referred to as Table 2) was prepared as follows.

<Preparation of Inorganic Solid Electrolyte-Containing Composition>

60 g of zirconia beads having a diameter of 5 mm was put into a 45 mL container made of zirconia (manufactured by FRITSCH), and 8.4 g of the LPS synthesized in the above Synthesis Example A, 0.6 g (solid content mass) of each binder solution shown in the column of “Binder solution” in Table 2, and 11 g (total amount) of butyl butyrate as the dispersion medium were put thereinto. Then, this container was set in a planetary ball mill P-7 (product name) manufactured by FRITSCH. Mixing was carried out at a temperature of 25° C. and a rotation speed of 150 rpm for 10 minutes to prepare each of inorganic solid electrolyte-containing compositions (slurries) K-1 to K-18 and Kc1 to Kc8.

<Preparation of Positive Electrode Composition>

60 g of zirconia beads having a diameter of 5 mm were put into a 45 mL container made of zirconia (manufactured by FRITSCH), and then 8.0 g of the LPS synthesized in Synthesis Example A, and 13 g (total amount) of butyl butyrate as a dispersion medium were put into the above container. The container was set in a planetary ball mill P-7 (product name, manufactured by FRITSCH) and the components were stirred for 30 minutes at 25° C. and a rotation speed of 200 rpm. Then, into this container, 27.5 g of NMC (manufactured by Sigma-Aldrich Co., LLC) as the positive electrode active material, 1.0 g of acetylene black (AB) as the conductive auxiliary agent, and 0.5 g (solid content mass) of the binder solution shown in “Binder solution” of Table 2 were put. The container was set in a planetary ball mill P-7, and mixing was continued for 30 minutes at a temperature of 25° C. and a rotation speed of 200 rpm to prepare each of positive electrode compositions (slurries) PK-1 to PK-18 and PKc1 to PKc8.

<Preparation of Negative Electrode Composition>

60 g of zirconia beads having a diameter of 5 mm was put into a 45 mL container made of zirconia (manufactured by FRITSCH), and 8.0 g of the LPS synthesized in the above Synthesis Example A, 0.4 g (solid content mass) of each binder solution shown in “Binder solution” of Table 2, and 17.5 g (total amount) of the dispersion medium shown in Table 1 were put thereinto. The container was set in a planetary ball mill P-7 (product name, manufactured by FRITSCH) and the components were mixed for 60 minutes at a temperature of 25° C. and a rotation speed of 300 rpm. Then, 9.5 g of silicon (Si, manufactured by Sigma-Aldrich Co., LLC) as the negative electrode active material and 1.0 g of VGCF (manufactured by Showa Denko K.K.) as the conductive auxiliary agent were put into the container. Similarly, the container was subsequently set in a planetary ball mill P-7, and mixing was carried out at 25° C. for 10 minutes at a rotation speed of 100 rpm to prepare each of negative electrode compositions (slurries) NK-1 to NK-18 and NKc1 to NKc8.

TABLE 2-1

| | | Inorganic solid electrolyte | | | Binder solution | | | Dispersion medium | | |
|---|---|---|---|---|---|---|---|---|---|---|
| | | | Composition | Solid content | | Composition | Solid content | | Composition | |
| | No. | | content | content | | content | content | | content | Note |
| Inorganic | K-1 | LPS | 42 | 93 | S-1 | 3 | 7 | Butyl butyrate | 55 | Present invention |
| solid | K-2 | LPS | 42 | 93 | S-2 | 3 | 7 | Butyl butyrate | 55 | Present invention |
| electrolyte- | K-3 | LPS | 42 | 93 | S-3 | 3 | 7 | Butyl butyrate | 55 | Present invention |
| containing | K-4 | LPS | 42 | 93 | S-4 | 3 | 7 | Butyl butyrate | 55 | Present invention |
| composition | K-5 | LPS | 42 | 93 | S-5 | 3 | 7 | Butyl butyrate | 55 | Present invention |
| | K-6 | LPS | 42 | 93 | S-6 | 3 | 7 | Butyl butyrate | 55 | Present invention |
| | K-7 | LPS | 42 | 93 | S-7 | 3 | 7 | Butyl butyrate | 55 | Present invention |
| | K-8 | LPS | 42 | 93 | S-8 | 3 | 7 | Butyl butyrate | 55 | Present invention |
| | K-9 | LPS | 42 | 93 | S-9 | 3 | 7 | Butyl butyrate | 55 | Present invention |
| | K-10 | LPS | 42 | 93 | S-10 | 3 | 7 | Butyl butyrate | 55 | Present invention |
| | K-11 | LPS | 42 | 93 | S-11 | 3 | 7 | Butyl butyrate | 55 | Present invention |
| | K-12 | LPS | 42 | 93 | S-12 | 3 | 7 | Butyl butyrate | 55 | Present invention |
| | K-13 | LPS | 42 | 93 | S-13 | 3 | 7 | Butyl butyrate | 55 | Present invention |
| | K-14 | LPS | 42 | 93 | S-14 | 3 | 7 | Butyl butyrate | 55 | Present invention |
| | K-15 | LPS | 42 | 93 | S-15 | 3 | 7 | Butyl butyrate | 55 | Present invention |
| | K-16 | LPS | 42 | 93 | S-16 | 3 | 7 | Butyl butyrate | 55 | Present invention |
| | K-17 | LPS | 42 | 93 | S-17 | 3 | 7 | Butyl butyrate | 55 | Present invention |
| | K-18 | LPS | 42 | 93 | S-18 | 3 | 7 | Butyl butyrate | 55 | Present invention |
| | Kc1 | LPS | 42 | 93 | T-1 | 3 | 7 | Butyl butyrate | 55 | Comparative Example |
| | Kc2 | LPS | 42 | 93 | T-2 | 3 | 7 | Butyl butyrate | 55 | Comparative Example |
| | Kc3 | LPS | 42 | 93 | T-3 | 3 | 7 | Butyl butyrate | 55 | Comparative Example |
| | Kc4 | LPS | 42 | 93 | T-4 | 3 | 7 | Butyl butyrate | 55 | Comparative Example |
| | Kc5 | LPS | 42 | 93 | T-5 | 3 | 7 | Butyl butyrate | 55 | Comparative Example |
| | Kc6 | LPS | 42 | 93 | T-6 | 3 | 7 | Butyl butyrate | 55 | Comparative Example |
| | Kc7 | LPS | 42 | 93 | T-7 | 3 | 7 | Butyl butyrate | 55 | Comparative Example |
| | Kc8 | LPS | 42 | 93 | T-8 | 3 | 7 | Butyl butyrate | 55 | Comparative Example |

TABLE 2-2

| | | Inorganic | | | | | | Dispersion | | | | | Conductive | | | |
|---|---|---|---|---|---|---|---|---|---|---|---|---|---|---|---|---|
| | | solid electrolyte | | | Binder solution | | | medium | | Active material | | | auxiliary agent | | | |
| | | | Com- | Solid | | Com- | Solid | | Com- | | Com- | Solid | | Com- | Solid | |
| | | | position | content | | position | content | | position | | position | content | | position | content | |
| | No. | | content | content | | content | content | | content | | content | content | | content | content | Note |
| Com- | PK-1 | LPS | 16 | 22 | S-1 | 1 | 1 | Butyl | 26 | NMC | 55 | 74 | AB | 2 | 3 | Present |
| po- | | | | | | | | butyrate | | | | | | | | invention |
| sition | PK-2 | LPS | 16 | 22 | S-2 | 1 | 1 | Butyl | 26 | NMC | 55 | 74 | AB | 2 | 3 | Present |
| for | | | | | | | | butyrate | | | | | | | | invention |
| pos- | PK-3 | LPS | 16 | 22 | S-3 | 1 | 1 | Butyl | 26 | NMC | 55 | 74 | AB | 2 | 3 | Present |
| itive | | | | | | | | butyrate | | | | | | | | invention |
| elec- | PK-4 | LPS | 16 | 22 | S-4 | 1 | 1 | Butyl | 26 | NMC | 55 | 74 | AB | 2 | 3 | Present |
| trode | | | | | | | | butyrate | | | | | | | | invention |
| | PK-5 | LPS | 16 | 22 | S-5 | 1 | 1 | Butyl | 26 | NMC | 55 | 74 | AB | 2 | 3 | Present |
| | | | | | | | | butyrate | | | | | | | | invention |
| | PK-6 | LPS | 16 | 22 | S-6 | 1 | 1 | Butyl | 26 | NMC | 55 | 74 | AB | 2 | 3 | Present |
| | | | | | | | | butyrate | | | | | | | | invention |
| | PK-7 | LPS | 16 | 22 | S-7 | 1 | 1 | Butyl | 26 | NMC | 55 | 74 | AB | 2 | 3 | Present |
| | | | | | | | | butyrate | | | | | | | | invention |
| | PK-8 | LPS | 16 | 22 | S-8 | 1 | 1 | Butyl | 26 | NMC | 55 | 74 | AB | 2 | 3 | Present |
| | | | | | | | | butyrate | | | | | | | | invention |
| | PK-9 | LPS | 16 | 22 | S-9 | 1 | 1 | Butyl | 26 | NMC | 55 | 74 | AB | 2 | 3 | Present |
| | | | | | | | | butyrate | | | | | | | | invention |
| | PK-10 | LPS | 16 | 22 | S-10 | 1 | 1 | Butyl | 26 | NMC | 55 | 74 | AB | 2 | 3 | Present |
| | | | | | | | | butyrate | | | | | | | | invention |
| | PK-11 | LPS | 16 | 22 | S-11 | 1 | 1 | Butyl | 26 | NMC | 55 | 74 | AB | 2 | 3 | Present |
| | | | | | | | | butyrate | | | | | | | | invention |
| | PK-12 | LPS | 16 | 22 | S-12 | 1 | 1 | Butyl | 26 | NMC | 55 | 74 | AB | 2 | 3 | Present |
| | | | | | | | | butyrate | | | | | | | | invention |
| | PK-13 | LPS | 16 | 22 | S-13 | 1 | 1 | Butyl | 26 | NMC | 55 | 74 | AB | 2 | 3 | Present |
| | | | | | | | | butyrate | | | | | | | | invention |
| | PK-14 | LPS | 16 | 22 | S-14 | 1 | 1 | Butyl | 26 | NMC | 55 | 74 | AB | 2 | 3 | Present |
| | | | | | | | | butyrate | | | | | | | | invention |
| | PK-15 | LPS | 16 | 22 | S-15 | 1 | 1 | Butyl | 26 | NMC | 55 | 74 | AB | 2 | 3 | Present |
| | | | | | | | | butyrate | | | | | | | | invention |
| | PK-16 | LPS | 16 | 22 | S-16 | 1 | 1 | Butyl | 26 | NMC | 55 | 74 | AB | 2 | 3 | Present |
| | | | | | | | | butyrate | | | | | | | | invention |
| | PK-17 | LPS | 16 | 22 | S-17 | 1 | 1 | Butyl | 26 | NMC | 55 | 74 | AB | 2 | 3 | Present |
| | | | | | | | | butyrate | | | | | | | | invention |
| | PK-18 | LPS | 16 | 22 | S-18 | 1 | 1 | Butyl | 26 | NMC | 55 | 74 | AB | 2 | 3 | Present |
| | | | | | | | | butyrate | | | | | | | | invention |
| | PKc1 | LPS | 16 | 22 | T-1 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc2 | LPS | 16 | 22 | T-2 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc3 | LPS | 16 | 22 | T-3 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc4 | LPS | 16 | 22 | T-4 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc5 | LPS | 16 | 22 | T-5 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc6 | LPS | 16 | 22 | T-6 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc7 | LPS | 16 | 22 | T-7 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |
| | PKc8 | LPS | 16 | 22 | T-8 | 1 | 1 | Butyl | 26 | NMC | 55 | 74 | AB | 2 | 3 | Com- |
| | | | | | | | | butyrate | | | | | | | | parative |
| | | | | | | | | | | | | | | | | Example |

TABLE 2-3

| | | Inorganic | | | | | | | | | | | Conductive | | | |
|---|---|---|---|---|---|---|---|---|---|---|---|---|---|---|---|---|
| | | solid electrolyte | | | Binder solution | | | | | Active material | | | auxiliary agent | | | |
| | | | | Solid | | | Solid | Dispersion | | | | Solid | | | Solid | |
| | | | | con- | | | con- | medium | | | | con- | | | con- | |
| | | | Com- | tent | | Com- | tent | | Com- | | Com- | tent | | Com- | tent | |
| | | | position | con- | | position | con- | | position | | position | con- | | position | con- | |
| | No. | | content | tent | | content | tent | | content | | content | tent | | content | tent | Note |
| Com- | NK-1 | LPS | 22 | 42 | S-1 | 1 | 2 | Butyl | 48 | Si | 26 | 50 | VGCF | 3 | 6 | Present |
| po- | | | | | | | | butyrate | | | | | | | | invention |
| sition | NK-2 | LPS | 22 | 42 | S-2 | 1 | 2 | Butyl | 48 | Si | 26 | 50 | VGCF | 3 | 6 | Present |
| for | | | | | | | | butyrate | | | | | | | | invention |
| neg- | NK-3 | LPS | 22 | 42 | S-3 | 1 | 2 | Butyl | 48 | Si | 26 | 50 | VGCF | 3 | 6 | Present |
| ative | | | | | | | | butyrate | | | | | | | | invention |
| elec- | NK-4 | LPS | 22 | 42 | S-4 | 1 | 2 | Butyl | 48 | Si | 26 | 50 | VGCF | 3 | 6 | Present |
| trode | | | | | | | | butyrate | | | | | | | | invention |
| | NK-5 | LPS | 22 | 42 | S-5 | 1 | 2 | Butyl | 48 | Si | 26 | 50 | VGCF | 3 | 6 | Present |
| | | | | | | | | butyrate | | | | | | | | invention |
| | NK-6 | LPS | 22 | 42 | S-6 | 1 | 2 | Butyl | 48 | Si | 26 | 50 | VGCF | 3 | 6 | Present |
| | | | | | | | | butyrate | | | | | | | | invention |
| | NK-7 | LPS | 22 | 42 | S-7 | 1 | 2 | Butyl | 48 | Si | 26 | 50 | VGCF | 3 | 6 | Present |
| | | | | | | | | butyrate | | | | | | | | invention |
| | NK-8 | LPS | 22 | 42 | S-8 | 1 | 2 | Butyl | 48 | Si | 26 | 50 | VGCF | 3 | 6 | Present |
| | | | | | | | | butyrate | | | | | | | | invention |
| | NK-9 | LPS | 22 | 42 | S-9 | 1 | 2 | Butyl | 48 | Si | 26 | 50 | VGCF | 3 | 6 | Present |
| | | | | | | | | butyrate | | | | | | | | invention |
| | NK-10 | LPS | 22 | 42 | S-10 | 1 | 2 | Butyl | 48 | Si | 26 | 50 | VGCF | 3 | 6 | Present |
| | | | | | | | | butyrate | | | | | | | | invention |
| | NK-11 | LPS | 22 | 42 | S-11 | 1 | 2 | Butyl | 48 | Si | 26 | 50 | VGCF | 3 | 6 | Present |
| | | | | | | | | butyrate | | | | | | | | invention |
| | NK-12 | LPS | 22 | 42 | S-12 | 1 | 2 | Butyl | 48 | Si | 26 | 50 | VGCF | 3 | 6 | Present |
| | | | | | | | | butyrate | | | | | | | | invention |
| | NK-13 | LPS | 22 | 42 | S-13 | 1 | 2 | Butyl | 48 | Si | 26 | 50 | VGCF | 3 | 6 | Present |
| | | | | | | | | butyrate | | | | | | | | invention |
| | NK-14 | LPS | 22 | 42 | S-14 | 1 | 2 | Butyl | 48 | Si | 26 | 50 | VGCF | 3 | 6 | Present |
| | | | | | | | | butyrate | | | | | | | | invention |
| | NK-15 | LPS | 22 | 42 | S-15 | 1 | 2 | Butyl | 48 | Si | 26 | 50 | VGCF | 3 | 6 | Present |
| | | | | | | | | butyrate | | | | | | | | invention |
| | NK-16 | LPS | 22 | 42 | S-16 | 1 | 2 | Butyl | 48 | Si | 26 | 50 | VGCF | 3 | 6 | Present |
| | | | | | | | | butyrate | | | | | | | | invention |
| | NK-17 | LPS | 22 | 42 | S-17 | 1 | 2 | Butyl | 48 | Si | 26 | 50 | VGCF | 3 | 6 | Present |
| | | | | | | | | butyrate | | | | | | | | invention |
| | NK-18 | LPS | 22 | 42 | S-18 | 1 | 2 | Butyl | 48 | Si | 26 | 50 | VGCF | 3 | 6 | Present |
| | | | | | | | | butyrate | | | | | | | | invention |
| | NKc1 | LPS | 22 | 42 | T-1 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc2 | LPS | 22 | 42 | T-2 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc3 | LPS | 22 | 42 | T-3 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc4 | LPS | 22 | 42 | T-4 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc5 | LPS | 22 | 42 | T-5 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc6 | TPS | 22 | 42 | T-6 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc7 | LPS | 22 | 42 | T-7 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |
| | NKc8 | LPS | 22 | 42 | T-8 | 1 | 2 | Butyl | 48 | Si | 26 | 50 | VGCF | 3 | 6 | Com- |
| | | | | | | | | butyrate | | | | | | | | parative |
| | | | | | | | | | | | | | | | | Example |

<Abbreviations in Table>

LPS: LPS synthesized in Synthesis Example A

NMC: LiNi_{1/3}Co_{1/3}Mn_{1/3}O₂

Si: Silicon

AB: Acetylene black

VGCF: Carbon nanotube

<Production of Solid Electrolyte Sheet for all-Solid State Secondary Battery>

Each of the inorganic solid electrolyte-containing compositions shown in the column of “Solid electrolyte composition No.” of Table 3-1, obtained as described above, was applied onto an aluminum foil having a thickness of 20 μm using a baker type applicator (product name: SA-201, manufactured by Tester Sangyo Co., Ltd.) and heated at 100° C. for 2 hours to dry (to remove the dispersion medium while causing the functional groups or partial structures to undergo a chemical reaction with each other) the inorganic solid electrolyte-containing composition. Then, using a heat press machine, the inorganic solid electrolyte-containing composition dried at a temperature of 120° C. and a pressure of 40 MPa for 10 seconds was heated and pressurized to produce each of solid electrolyte sheets 101 to 118, c11 to c15, and c26 to c28 for an all-solid state secondary battery (in Table 3-1, it is described as “Solid electrolyte sheet”). The film thickness of the solid electrolyte layer was 50 μm.

<Production of Positive Electrode Sheet for all-Solid State Secondary Battery>

Each of the positive electrode compositions obtained as described above, which is shown in the column of “Positive electrode composition No.” in Table 3-2, was applied onto an aluminum foil having a thickness of 20 μm by using a baker type applicator (product name: SA-201), heating was carried out at 100° C. for 1 hour, and then heating was further carried out at 110° C. for 1 hour to dry (to remove the dispersion medium while causing the functional groups or partial structures to undergo a chemical reaction with each other) the positive electrode composition. Then, using a heat press machine, the dried positive electrode composition was pressurized (10 MPa, 1 minute) at 25° C. to produce each of positive electrode sheets 119 to 136, c16 to c20, and c29 to c31 for an all-solid state secondary battery, having a positive electrode active material layer having a film thickness of 80 μm (in Table 3-2, it is described as “Positive electrode sheet”).

<Production of Negative Electrode Sheet for all-Solid State Secondary Battery>

Each of the negative electrode compositions obtained as described above, which is shown in the column of “Negative electrode composition No.” in Table 3-3, was applied onto a copper foil having a thickness of 20 μm by using a baker type applicator (product name: SA-201), heating was carried out at 100° C. for 1 hour, and then heating was further carried out at 110° C. for 1 hour to dry (to remove the dispersion medium while causing the functional groups or partial structures to undergo a chemical reaction with each other) the negative electrode composition. Then, using a heat press machine, the dried negative electrode composition was pressurized (10 MPa, 1 minute) at 25° C. to produce each of negative electrode sheets 137 to 154, c21 to c25, and c32 to c34 for an all-solid state secondary battery, having a negative electrode active material layer having a film thickness of 70 μm (in Table 3-3, it is described as “Negative electrode sheet”).

<Evaluation 1: Dispersion Stability>

Each of the prepared compositions (slurries) was put into a glass test tube having a diameter of 10 mm and a height of 4 cm up to a height of 4 cm and allowed to stand at 25° C. for 24 hours. The solid content ratio between the solid contents before and after allowing the standing was calculated the slurry within 1 cm from the slurry liquid surface. Specifically, immediately after allowing the standing, the liquid down to 1 cm below the slurry liquid surface was taken out and dried by heating in an aluminum cup at 120° C. for 2 hours. Then, the mass of the solid content in the cup was measured to determine the solid content before and after allowing standing. The solid content obtained in this manner was used to determine the solid content ratio [WA/WB] of the solid content WA after allowing standing to the solid content WB before allowing standing.

The ease of sedimentation (precipitation) of the inorganic solid electrolyte was evaluated as the dispersion stability of the inorganic solid electrolyte-containing composition by determining where the above solid content ratio is included in any of the following evaluation standards. In this test, it is indicated that the closer the solid content ratio is to 1, the better the dispersion stability is, and the evaluation standard “C” or higher is the pass level. The results are shown in Table 3.

—Evaluation Standards—

A: 0.9≤solid content ratio≤1.0

B: 0.6:≤solid content ratio<0.9

C: 0.3≤solid content ratio<0.6

D: solid content ratio<0.3

<Evaluation 2: Handleability>

The constitutional layers (the solid electrolyte layers or the electrode active material layers) of each solid electrolyte sheet for an all-solid state secondary battery, each positive electrode sheet for an all-solid state secondary battery, and each negative electrode sheet for an all-solid state secondary battery were peeled off from the base material (the aluminum foil or the copper foil), and then test pieces having a length of 20 mm and a width of 20 mm were cut. Using a constant pressure thickness measuring device (manufactured by TECLOCK Co., Ltd.), the layer thicknesses at 5 points of this test piece were measured, and the arithmetic mean value of the layer thicknesses was calculated.

From each measured value and the arithmetic mean value thereof, the large deviation value (the maximum deviation value) among the deviation values (%) obtained according to Expression (a) or (b) below was applied to the following evaluation standard to evaluate handleability. In this test, it is indicated that the smaller the maximum deviation value (%) is, the more uniform the layer thickness of the solid electrolyte layer or the active material layer is, that is, each composition exhibits a proper viscosity (fluidity) and thus a coating film in which the surface of a film to be formed is flat can be formed (excellent in handleability). In this test, an evaluation standard of “F” or higher is the pass level. The results are shown in Table 3.

100×(the maximum value among the layer thicknesses at the 5 points−the arithmetic mean value)/(the arithmetic mean value) Expression (a):

100×(the minimum value among the layer thicknesses at the 5 points−the arithmetic mean value)/(the arithmetic mean value) Expression (b):

The measurement points of the layer thickness were the following “5 points: A to E” for each test piece.

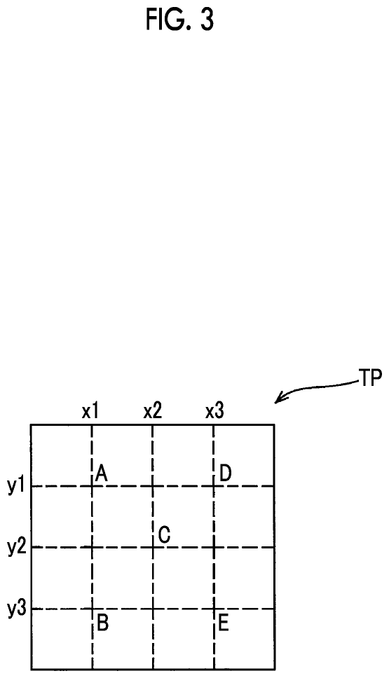

First, as shown in FIG. 3, three virtual lines y1, y2, and y3, which divide the vertical direction of the test piece TP into four equal parts are drawn, and then three virtual lines x1, x2, and x3, which divide the lateral direction of the test piece TP into four equal parts are drawn in the same manner, whereby the surface of the test piece TP is divided into a lattice form.

The measurement points are the intersection A of the virtual lines x1 and y1, the intersection B of the virtual lines x1 and y3, the intersection C of the virtual lines x2 and y2, the intersection D of the virtual lines x3 and y1, and the intersection E of the virtual lines x3 and y3.

—Evaluation Standards—

A: Maximum deviation value<3%

B: 3%≤maximum deviation value<5%

C: 5%:≤maximum deviation value<10%

D: 10%≤maximum deviation value

TABLE 3-1

| | | Solid electrolyte | Binder | | | |
|---|---|---|---|---|---|---|
| | | composition | solution | Dispersion | | |
| | Sheet No. | No. | No. | stability | Handleability | Note |
| Solid | 101 | K-1 | S-1 | B | C | Present invention |
| electrolyte | 102 | K-2 | S-2 | B | C | Present invention |
| sheet | 103 | K-3 | S-3 | B | C | Present invention |
| | 104 | K-4 | S-4 | C | C | Present invention |
| | 105 | K-5 | S-5 | C | C | Present invention |
| | 106 | K-6 | S-6 | C | C | Present invention |
| | 107 | K-7 | S-7 | B | C | Present invention |
| | 108 | K-8 | S-8 | C | C | Present invention |
| | 109 | K-9 | S-9 | C | C | Present invention |
| | 110 | K-10 | S-10 | B | B | Present invention |
| | 111 | K-11 | S-11 | B | B | Present invention |
| | 112 | K-12 | S-12 | B | B | Present invention |
| | 113 | K-13 | S-13 | B | B | Present invention |
| | 114 | K-14 | S-14 | B | B | Present invention |
| | 115 | K-15 | S-15 | B | B | Present invention |
| | 116 | K-16 | S-16 | C | C | Present invention |
| | 117 | K-17 | S-17 | C | C | Present invention |
| | 118 | K-18 | S-18 | C | C | Present invention |
| | c11 | Kc1 | T-1 | D | D | Comparative Example |
| | c12 | Kc2 | T-2 | D | D | Comparative Example |
| | c13 | Kc3 | T-3 | D | D | Comparative Example |
| | c14 | Kc4 | T-4 | D | D | Comparative Example |
| | c15 | Kc5 | T-5 | D | D | Comparative Example |
| | c26 | Kc6 | T-6 | D | D | Comparative Example |
| | c27 | Kc7 | T-7 | D | D | Comparative Example |
| | c28 | Kc8 | T-8 | D | D | Comparative Example |

TABLE 3-2

| | | Positive electrode | Binder | | | |
|---|---|---|---|---|---|---|
| | | composition | solution | Dispersion | | |
| | Sheet No. | No. | No. | stability | Handleability | Note |
| Positive | 119 | PK-1 | S-1 | B | B | Present invention |
| electrode | 120 | PK-2 | S-2 | B | B | Present invention |
| sheet | 121 | PK-3 | S-3 | B | B | Present invention |
| | 122 | PK-4 | S-4 | C | C | Present invention |
| | 123 | PK-5 | S-5 | C | C | Present invention |
| | 124 | PK-6 | S-6 | C | C | Present invention |
| | 125 | PK-7 | S-7 | B | B | Present invention |
| | 126 | PK-8 | S-8 | C | C | Present invention |
| | 127 | PK-9 | S-9 | C | C | Present invention |
| | 128 | PK-10 | S-10 | B | B | Present invention |
| | 129 | PK-11 | S-11 | B | B | Present invention |
| | 130 | PK-12 | S-12 | B | B | Present invention |
| | 131 | PK-13 | S-13 | B | A | Present invention |
| | 132 | PK-14 | S-14 | B | A | Present invention |
| | 133 | PK-15 | S-15 | B | A | Present invention |
| | 134 | PK-16 | S-16 | C | C | Present invention |
| | 135 | PK-17 | S-17 | C | C | Present invention |
| | 136 | PK-18 | S-18 | C | C | Present invention |
| | c16 | PKc1 | T-1 | D | D | Comparative Example |
| | c17 | PKc2 | T-2 | D | D | Comparative Example |
| | c18 | PKc3 | T-3 | D | D | Comparative Example |
| | c19 | PKc4 | T-4 | D | D | Comparative Example |
| | c20 | PKc5 | T-5 | D | D | Comparative Example |
| | c29 | PKc6 | T-6 | D | D | Comparative Example |
| | c30 | PKc7 | T-7 | D | D | Comparative Example |
| | c31 | PKc8 | T-8 | D | D | Comparative Example |

TABLE 3-3

| | | Negative electrode | Binder | | | |
|---|---|---|---|---|---|---|
| | | composition | solution | Dispersion | | |
| | Sheet No. | No. | No. | stability | Handleability | Note |
| Negative | 137 | NK-1 | S-1 | B | B | Present invention |
| electrode | 138 | NK-2 | S-2 | B | B | Present invention |
| sheet | 139 | NK-3 | S-3 | B | B | Present invention |
| | 140 | NK-4 | S-4 | C | C | Present invention |
| | 141 | NK-5 | S-5 | C | C | Present invention |
| | 142 | NK-6 | S-6 | C | C | Present invention |
| | 143 | NK-7 | S-7 | B | B | Present invention |
| | 144 | NK-8 | S-8 | C | C | Present invention |
| | 145 | NK-9 | S-9 | C | C | Present invention |
| | 146 | NK-10 | S-10 | B | B | Present invention |
| | 147 | NK-11 | S-11 | B | B | Present invention |
| | 148 | NK-12 | S-12 | B | B | Present invention |
| | 149 | NK-13 | S-13 | B | A | Present invention |
| | 150 | NK-14 | S-14 | B | A | Present invention |
| | 151 | NK-15 | S-15 | B | B | Present invention |
| | 152 | NK-16 | S-16 | C | C | Present invention |
| | 153 | NK-17 | S-17 | C | C | Present invention |
| | 154 | NK-18 | S-18 | C | C | Present invention |
| | c21 | NKc1 | T-1 | D | D | Comparative Example |
| | c22 | NKc2 | T-2 | D | D | Comparative Example |
| | c23 | NKc3 | T-3 | D | D | Comparative Example |
| | c24 | NKc4 | T-4 | D | D | Comparative Example |
| | c25 | NKc5 | T-5 | D | D | Comparative Example |
| | c32 | NKc6 | T-6 | D | D | Comparative Example |
| | c33 | NKc7 | T-7 | D | D | Comparative Example |
| | c34 | NKc8 | T-8 | D | D | Comparative Example |

<Manufacturing of all-Solid State Secondary Battery>

An all-solid state secondary battery (No. 101) having a layer configuration illustrated in FIG. 1 was manufactured as follows.

(Production of Positive Electrode Sheet for all-Solid State Secondary Battery, which has Solid Electrolyte Layer)

The solid electrolyte sheet shown in the column of “Solid electrolyte layer” of Table 4-1, prepared as described above, was overlaid on the positive electrode active material layer of each of the positive electrode sheets for an all-solid state secondary battery shown in the column of “Electrode active material layer” of Table 4-1 so that it came into contact with the positive electrode active material layer, transferred (laminated) by being pressurized at 50 MPa and 25° C. using a press machine, and then pressurized at 600 MPa and at 25° C., whereby each of positive electrode sheets 119 to 136, c16 to c20, and c29 to c31 for an all-solid state secondary battery having a thickness of 30 μm (thickness of positive electrode active material layer: 60 μm) was produced.

(Production of Negative Electrode Sheet for all-Solid State Secondary Battery, which has Solid Electrolyte Layer)

Next, the solid electrolyte sheet shown in the column of “Solid electrolyte layer” of Table 4-2, prepared as described above, was overlaid on the negative electrode active material layer of each of the negative electrode sheets for an all-solid state secondary battery shown in the column of “Electrode active material layer” of Table 4-2 so that it came into contact with the negative electrode active material layer, transferred (laminated) by being pressurized at 50 MPa and 25° C. using a press machine, and then pressurized at 600 MPa and at 25° C., whereby each of negative electrode sheets 137 to 154, c21 to c25, and c32 to c34 for an all-solid state secondary battery having a thickness of 30 μm (thickness of negative electrode active material layer: 50 μm) was produced.

(Manufacture of all-Solid State Secondary Battery)

1. Manufacturing of all-Solid State Secondary Batteries Nos. 101 to 118, c101 to c105, and c111 to c113

The positive electrode sheet No. 119 for an all-solid state secondary battery (the aluminum foil of the solid electrolyte-containing sheet had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. After further overlaying a stainless steel foil thereon, the 2032-type coin case 11 was crimped to manufacture an all-solid state secondary battery 13 (No. 101), illustrated in FIG. 2. The all-solid state secondary battery (the half cell) manufactured in this manner has a layer configuration illustrated in FIG. 1 (however, the lithium foil corresponds to a negative electrode active material layer 2 and a negative electrode collector 1).

Each of all-solid state secondary batteries (half cells) Nos. 102 to 118, c101 to c05, and c111 to c113 was manufactured in the same manner as in the manufacturing of the all-solid state secondary battery (No. 101) except that in the manufacturing of the all-solid state secondary battery No. 101, a positive electrode sheet for an all-solid state secondary battery, which has a solid electrolyte layer and is indicated by No. shown in the column of “Electrode active material layer” of Table 4-1 was used instead of the positive electrode sheet No. 119 for a secondary battery, which has a solid electrolyte layer.

2. Manufacturing of all-Solid State Secondary Batteries Nos. 119 to 136, c106 to c110, and c114 to c116

The negative electrode sheet No. 137 for an all-solid state secondary battery (the aluminum foil of the solid electrolyte-containing sheet had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. After further overlaying a stainless steel foil thereon, the 2032-type coin case 11 was crimped to produce an all-solid state secondary battery (a half cell) No. 119 illustrated in FIG. 2.

A positive electrode sheet for an all-solid state secondary battery to be used in the manufacturing of the all-solid state secondary battery (No. 119) was prepared as follows.

(Preparation of Positive Electrode Composition)

180 beads of zirconia beads having a diameter of 5 mm were put into a 45 mL container made of zirconia (manufactured by FRITSCH), 2.7 g of the LPS synthesized in the above Synthesis Example A, and 0.3 g of KYNAR FLEX 2500-20 (product name, PVdF-HFP: polyvinylidene fluoride—hexafluoropropylene copolymer, manufactured by Arkema S.A.) in terms of a solid content mass and 22 g of butyl butyrate were put into the above container. The container was set in a planetary ball mill P-7 (product name, manufactured by FRITSCH) and the components were stirred for 60 minutes at 25° C. and a rotation speed of 300 rpm. Then, 7.0 g of LiNi_{1/3}Co_{1/3}Mn_{1/3}O₂ (NMC) was put into container as the positive electrode active material, and similarly, the container was set in a planetary ball mill P-7, mixing was continued at 25° C. and a rotation speed of 100 rpm for 5 minutes to prepare a positive electrode composition.

(Production of Positive Electrode Sheet for all-Solid State Secondary Battery)

The positive electrode composition obtained as described above was applied onto an aluminum foil (a positive electrode collector) having a thickness of 20 μm with a baker type applicator (product name: SA-201, manufactured by Tester Sangyo Co., Ltd.), heating was carried out at 100° C. for 2 hours to dry (to remove the dispersion medium) the positive electrode composition. Then, using a heat press machine, the dried positive electrode composition was pressurized (10 MPa, 1 minute) at 25° C. to produce each of positive electrode sheets for an all-solid state secondary battery, having a positive electrode active material layer having a film thickness of 80 μm.

Each of all-solid state secondary batteries (full cells) Nos. 120 to 136, c106 to c110, and c114 to c116 was manufactured in the same manner as in the manufacturing of the all-solid state secondary battery No. 119 except that in the manufacturing of the all-solid state secondary battery No. 119, a negative electrode sheet for an all-solid state secondary battery, which has a solid electrolyte layer and is indicated by No. shown in the column of “Electrode active material layer” of Table 4-2 was used instead of the negative electrode sheet No. 137 for an all-solid state secondary battery, which has a solid electrolyte layer.

<Evaluation 3: Cycle Characteristic Test>

The discharge capacity retention rate of each of the all-solid state secondary batteries manufactured as described above was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the above charging and discharging cycle was repeated, and the discharge capacity of each of the all-solid state secondary batteries was measured at each time after the charging and discharging cycle was carried out with a charging and discharging evaluation device: TOSCAT-3000 (product name).

In a case where the discharge capacity (the initial discharge capacity) of the first charging and discharging cycle after initialization is set to 100%, the battery performance (the cycle characteristics) was evaluated by determining where the number of charging and discharging cycles in a case where the discharge capacity retention rate (the discharge capacity with respect to the initial discharge capacity) reaches 80% is included in any of the following evaluation standards. In this test, the higher the evaluation standard is, the better the battery performance (the cycle characteristics) is, and the initial battery performance can be maintained even in a case where a plurality of times of charging and discharging are repeated (even in a case of the long-term use). The pass level of this test is “B” or higher in the all-solid state secondary battery Nos. 101 to 118, c101 to c105, and c11 to c113 using the positive electrode sheet for an all-solid state secondary battery shown in Table 4-1, and it is “C” or higher in the all-solid state secondary battery Nos. 119 to 136, c106 to c110, and c114 to c116 using the negative electrode sheet for an all-solid state secondary battery shown in Table 4-2.

All of the all-solid state secondary batteries Nos. 101 to 136 exhibited initial discharge capacity values sufficient for functioning as an all-solid state secondary battery.

—Evaluation Standards—

A: 500 cycles or more

B: 250 cycles or more and less than 500 cycles

C: 150 cycles or more and less than 250 cycles

D: 80 cycles or more and less than 150 cycles

E: Less than 80 cycles

<Evaluation 4: Measurement of Ion Conductivity>

The ion conductivity of each of the manufactured all-solid state secondary batteries was measured. Specifically, the alternating-current impedance of each of the all-solid state secondary batteries was measured in a constant-temperature tank (30° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (1).

Ion conductivity σ (mS/cm)=1,000×sample layer thickness (cm)/[resistance (Ω)×sample area (cm²)] Expression (1):

In Expression (1), the sample layer thickness is a value obtained by measuring the thickness before placing the laminate 12 in the 2032-type coin case 11 and subtracting the film thickness of the collector (the total layer thickness of the solid electrolyte layer and the electrode active material layer). The sample area is the area of the disk-shaped sheet having a diameter of 14.5 mm.

It was determined where the obtained ion conductivity σ was included in any of the following evaluation standards.

In this test, in a case where the evaluation standard is “D” or higher, the ion conductivity σ is the pass level.

—Evaluation Standards—

A: 0.60≤σ

B: 0.50≤σ<0.60

C: 0.30≤σ<0.50

D: 0.20≤σ<0.30

E: σ<0.20

TABLE 4-1

| | Layer configuration | | | | |
|---|---|---|---|---|---|
| | Electrode active | Solid electrolyte | | | |
| | material layer | layer | Cycle | Ion | |
| No. | (Sheet No,) | (Sheet No,) | characteristics | conductivity | Note |
| 101 | 119 | 101 | B | C | Present invention |
| 102 | 120 | 102 | B | C | Present invention |
| 103 | 121 | 103 | B | C | Present invention |
| 104 | 122 | 104 | B | B | Present invention |
| 105 | 123 | 105 | B | B | Present invention |
| 106 | 124 | 106 | B | C | Present invention |
| 107 | 125 | 107 | B | B | Present invention |
| 108 | 126 | 108 | B | B | Present invention |
| 109 | 127 | 109 | B | C | Present invention |
| 110 | 128 | 110 | B | A | Present invention |
| 111 | 129 | 111 | B | B | Present invention |
| 112 | 130 | 112 | B | A | Present invention |
| 113 | 131 | 113 | A | A | Present invention |
| 114 | 132 | 114 | A | A | Present invention |
| 115 | 133 | 115 | B | A | Present invention |
| 116 | 134 | 116 | B | C | Present invention |
| 117 | 135 | 117 | B | C | Present invention |
| 118 | 136 | 118 | B | C | Present invention |
| c101 | c16 | c11 | C | D | Comparative Example |
| c102 | c17 | c12 | C | D | Comparative Example |
| c103 | c18 | c13 | C | D | Comparative Example |
| c104 | c19 | c14 | C | D | Comparative Example |
| c105 | c20 | c15 | C | D | Comparative Example |
| c111 | c29 | c26 | C | D | Comparative Example |
| c112 | c30 | c27 | D | E | Comparative Example |
| c113 | c31 | c28 | C | D | Comparative Example |

TABLE 4-2

| | Layer configuration | | | | |
|---|---|---|---|---|---|
| | Electrode active | Solid electrolyte | | | |
| | material layer | layer | Cycle | Ion | |
| No. | (Sheet No,) | (Sheet No,) | characteristics | conductivity | Note |
| 119 | 137 | 101 | C | D | Present invention |
| 120 | 138 | 102 | C | D | Present invention |
| 121 | 139 | 103 | C | D | Present invention |
| 122 | 140 | 104 | B | C | Present invention |
| 123 | 141 | 105 | B | C | Present invention |
| 124 | 142 | 106 | C | D | Present invention |
| 125 | 143 | 107 | B | C | Present invention |
| 126 | 144 | 108 | B | C | Present invention |
| 127 | 145 | 109 | C | D | Present invention |
| 128 | 146 | 110 | B | B | Present invention |
| 129 | 147 | 111 | B | C | Present invention |
| 130 | 148 | 112 | B | B | Present invention |
| 131 | 149 | 113 | A | A | Present invention |
| 132 | 150 | 114 | A | A | Present invention |
| 133 | 151 | 115 | B | B | Present invention |
| 134 | 152 | 116 | C | D | Present invention |
| 135 | 153 | 117 | C | D | Present invention |
| 136 | 154 | 118 | C | D | Present invention |
| c106 | c21 | c11 | E | E | Comparative Example |
| c107 | c22 | c12 | E | E | Comparative Example |
| c108 | c23 | c13 | E | E | Comparative Example |
| c109 | c24 | c14 | E | E | Comparative Example |
| c110 | c25 | c15 | E | E | Comparative Example |
| c114 | c32 | c26 | E | E | Comparative Example |
| c115 | c33 | c27 | E | E | Comparative Example |
| c116 | c34 | c28 | E | E | Comparative Example |

The following facts can be seen from the results shown in Table 3, Table 4-1, and Table 4-2.

All the inorganic solid electrolyte-containing compositions that do not contain a component constituting the polymer binder defined in the present invention are inferior in dispersion stability, and moreover, the constitutional layer formed by using these compositions exhibits large unevenness of the coating thickness, and thus the handleability is also inferior. In addition, all-solid state secondary batteries using these compositions, which are inferior in dispersion stability and handleability, do not exhibit sufficient ion conductivity or cycle characteristics.

On the other hand, all the inorganic solid electrolyte-containing compositions containing the components constituting the polymer binder defined in the present invention have high levels of dispersion stability and handleability. It can be seen that by using this inorganic solid electrolyte-containing composition in the formation of the constitutional layer of the all-solid state secondary battery, it is possible to form a low-resistance constitutional layer having a flat surface, and it is possible to realize excellent cycle characteristics and high ion conductivity in the obtained all-solid state secondary battery. The above-described effect of the present invention is conceived to be because the soluble polymer defined in (C1) or (C2) defined in the present invention is dissolved in the inorganic solid electrolyte-containing composition and thus exhibits excellent dispersion characteristics, whereas in the constitutional layer, a polymer binder is formed due to a chemical reaction, and thus solid particles can be bound to each other while suppressing an increase in interface resistance.

Since the all-solid state secondary battery according to the embodiment of the present invention exhibits the above-described excellent characteristics, it exhibits excellent cycle characteristics even under high-speed charging and discharging conditions.

The present invention has been described together with the aspects of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

This application claims priority based on JP2020-061882 filed in Japan on Mar. 31, 2020, which is incorporated herein by reference as a part of the description of the present specification.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: laminate for all-solid state secondary battery
13: coin-type all-solid state secondary battery
TP; test piece

What is claimed is:

1. An inorganic solid electrolyte-containing composition comprising:
an inorganic solid electrolyte having an ion conductivity of a metal belonging to Group 1 or Group 2 in the periodic table;
the following component constituting a polymer binder; and
a dispersion medium,
wherein the component constituting a polymer binder includes a polymer defined in at least one of the following (C1) or (C2),
(C1) a soluble polymer C1-I having at least one functional group or partial structure selected from the following group (I), and a soluble polymer C1-11 having at least one functional group or partial structure selected from the following group (II),
(C2) a soluble polymer C2 having each of at least one functional group or partial structure selected from the following group (I), and at least one functional group or partial structure selected from the following group (II),
Group (I): a hydroxyl group, a primary or secondary amino group, and a 1,3-dicarbonyl structure,
Group (II): a blocked isocyanate group, a boronate group or borinate group, a boronic acid ester group or borinic acid ester group, and an acid anhydride structure.

2. The inorganic solid electrolyte-containing composition according to claim 1,
wherein at least one of the soluble polymers has 50% by mass or more of a constitutional component derived from a (meth)acrylic monomer or a vinyl monomer.

3. The inorganic solid electrolyte-containing composition according to claim 1,
wherein the inorganic solid electrolyte is a sulfide-based inorganic solid electrolyte.

4. The inorganic solid electrolyte-containing composition according to claim 1,
wherein the dispersion medium contains at least one selected from a ketone compound, an aliphatic compound, or an ester compound.

5. The inorganic solid electrolyte-containing composition according to claim 1, further comprising an active material.

6. The inorganic solid electrolyte-containing composition according to claim 1, further comprising a conductive auxiliary agent.

7. A sheet for an all-solid state secondary battery, comprising a layer formed of the inorganic solid electrolyte-containing composition according to claim 1.

8. An all-solid state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the inorganic solid electrolyte-containing composition according to claim 1.

9. A manufacturing method for a sheet for an all-solid state secondary battery, the manufacturing method comprising forming a film of the inorganic solid electrolyte-containing composition according to claim 1.

10. A manufacturing method for an all-solid state secondary battery, the manufacturing method comprising manufacturing an all-solid state secondary battery through the manufacturing method according to claim 9.
